(19) United States
(12) Patent Application Publication
(10) Pub. No.: US 2022/0206481 A1
(43) Pub. Date: Jun. 30, 2022

(54) SYSTEMS AND METHODS FOR BENCHMARKING OPERATOR PERFORMANCE FOR AN INDUSTRIAL OPERATION

(71) Applicant: Schneider Electric Systems USA, Inc., Foxborough, MA (US)

(72) Inventors: Randy Marvin Miller, Houston, TX (US); Stephen Mark Apple, Belton, TX (US); Mark Thomas Grant, Mansfield, MA (US); Hector Rodriguez Perez, Houston, TX (US)

(73) Assignee: Schneider Electric Systems USA, Inc., Foxborough, MA (US)

(21) Appl. No.: 17/566,187

(22) Filed: Dec. 30, 2021

Related U.S. Application Data
(60) Provisional application No. 63/132,661, filed on Dec. 31, 2020.

(51) Int. Cl. G05B 19/418; G06Q 10/06

(52) U.S. Cl. CPC G05B 19/41875; G05B 19/4185; G05B 2219/23067; G06Q 10/06398; G05B 2219/24215; G05B 19/41865

(57) ABSTRACT

Systems and methods for benchmarking operator performance for an industrial operation are disclosed herein. In one aspect of this disclosure, a method for benchmarking operator performance for an industrial operation includes receiving input data relating to the industrial operation from one or more data sources, and processing the input data to measure operator effectiveness and build a data repository for benchmarking/analytics. The data repository may include information relating to the measured operator effectiveness, for example. Biggest contributors of operator variability may be identified based on an analysis of the data repository, and one or more actions may be taken to reduce or eliminate the biggest contributors of operator variability.

### CROSS REFERENCE TO RELATED APPLICATION

This application claims the benefit of and priority to U.S. Provisional Application No. 63/132,661, filed on Dec. 31, 2020, which application was filed under 35 U.S.C. § 119(e) and is incorporated by reference herein in its entirety.

### FIELD

This disclosure relates generally to industrial operation management systems and methods, and more particularly, to systems and methods for benchmarking operator performance for an industrial operation.

### BACKGROUND

As is known, an industrial operation typically includes a plurality of industrial equipment. The industrial equipment can come in a variety of forms and may be of varying complexities, for example, depending on the industrial operation. For example, industrial process control and monitoring measurement devices are typically utilized to measure process variable measurements such as pressure, flow, level, temperature and analytical values in numerous industrial applications and market segments throughout Oil & Gas, Energy, Food & Beverage, Water & Waste Water, Chemical, Petrochemical, Pharmaceutical, Metals, Mining and Minerals and other industry applications.

As is known, the industrial equipment associated with an industrial operation is typically operated by one or more system operators. As is also known, there may be significant differences in how the operators operate the industrial equipment and other aspects of the industrial operation. However, the variations between the operators and shifts over which the operators operate the industrial equipment and other aspects of the industrial operation is typically not measured and is not well understood. The impact of operator to operator variations may be substantial and influence operation (e.g., productivity and profitability) of the industrial operation. For example, it is estimated by the Abnormal Situation Management Consortium that eighty billion dollars ($80B) per year is lost due to human (i.e., operator) root causes across the process industry. Therefore, it is desirable to better understand and minimize operator variations.

### SUMMARY

Described herein are systems and methods for benchmarking operator performance for an industrial operation. As used herein, operators correspond to humans that interact with at least one control system associated with the industrial operation. The industrial operation may include, for example, one or more continuous, piece wise continuous or batch industrial processes. The industrial processes may be associated with one or more industrial process facilities of: a refinery, a pulp mill, a paper mill, a chemical plant, a coal power plant, a mineral processing plant, a gas processing plant or liquified natural gas operation, and so forth.

In one aspect of this disclosure, a method for benchmarking operator performance for an industrial operation includes receiving input data relating to the industrial operation from one or more data sources, and processing the input data to measure operator effectiveness and build a data repository for benchmarking/analytics. The data repository may include information relating to the measured operator effectiveness. Biggest contributors of operator variability may be identified based on an analysis of the data repository, and one or more actions may be taken or performed to reduce or eliminate the biggest contributors of operator variability. The biggest contributors of operator variability may produce one or more gaps in the economic operation of the industrial operation. In accordance with some embodiments of this disclosure, the one or more gaps represent improvement potential during common process events or abnormal operation if all the variations between operators (i.e., all the variations between the best operator and the other operators) is removed.

In accordance with some embodiments of this disclosure, the variations are primarily different decisions and actions plus the timing of those actions taken either in response to an event or abnormal situation or a different decision taken during normal steady state operation. In the former case, one example could be the differences in the root cause analysis of a process upset such as a change in composition to the feed of a distillation column that lead to a different action taken from one operator to another such as increasing the heat in the reboiler five minutes after a low pressure alarm by one operator versus reducing the cooling in the overhead condenser a few seconds after the alarm (lowest impact to production) that by another operator. The real root causes in the different actions taken are primarily in the operating environment including the displays, alarm performance, advanced process control and operator training in simulators. For an operating environment that employs all or most of the situational awareness best practices, all operators take very similar actions in a timely fashion.

In accordance with some embodiments of this disclosure, the one or more gaps are gaps in production and/or profit between the best operator and all other operators. If all operators behave the same as the best operator, there is zero gap or benefit potential. This is what is expected in an operating environment that is highly effective. The other extreme is also true: a large gap between all operators and the best operator would lead to a high potential for production or profit improvement. This is what is expected in a very ineffective operating environment.

It is understood that the variations and gaps are related in accordance with some embodiments of this disclosure. For example, a variation may be referred to as a % measure that when aggregated for all operators represents the % improvement potential in the KPI (usually production). The root causes for the variation are linked to an ineffective operating environment. The variation itself is the linked to the different decisions/actions that different operators take in the exact same situation.

In accordance with some embodiments of this disclosure, the input data used for measuring operator effectiveness and building the data repository for benchmarking/analytics is parsed per industrial application associated with the industrial operation, and the operator effectiveness is separately measured for each industrial application. In some embodiments, each industrial application is associated with a different process or piece of equipment. Additionally, in some embodiments the industrial operation is associated with a plurality of sites (e.g., physical plant sites) and/or a plurality of customers (e.g., different customers). In these embodiments, the operator effectiveness may be measured for each of the plurality of sites alone or in combination with other sites of the plurality of sites.

It is understood that the operators for which operator effectiveness is measured may be responsible for monitoring and managing one or more aspects of the industrial operation. For example, the operators may be responsible for operating industrial equipment and/or processes associated with the industrial operation. The industrial equipment may be installed or located in/at one or more sites, for example, facilities (e.g., plants) or other physical locations (e.g., geographical areas). Additionally, the industrial processes may occur at or be associated with one or more sites.

In accordance with some embodiments of this disclosure, the input data is collected to a point where a data set produced from the input data is determined to be statistically significant. In accordance with some embodiments of this disclosure, the data set is analyzed to identify correlations between one or more metrics associated with the industrial operation. The one or more metrics may including, for example, at least one of: production rate stability, number of transitions between HMI graphics, number of loops in manual versus automatic, energy usage in kilowatts per unit, total time process loops are in manual vs automatic mode, total transitions from manual to automatic control of a process, tuning changes to control loops, count of alarm changes. In accordance with some embodiments of this disclosure, the one or more metrics are cross referenced with at least one of: shift time of day, shift length, shift manpower and experience levels of operators, to further identify the correlations. The one or more metrics may be analyzed, for example, using regression analyses and/or other analytics to identify the correlations. The correlations may be indicative of best practices at plants, for example, which may lead to key process indicators of operator effectiveness. In accordance with some embodiments of this disclosure, the operator actions are linked to at least one of the one or more metrics, and the linking is used, at least in part, to measure the operator effectiveness. For example, in one example implementation, operator actions can be linked to a variety of metrics and through a collection of metrics it will be shown that the metrics directly correlate to operator effectiveness. From this correlation, monetary losses and quality may be improved.

In accordance with some embodiments of this disclosure, the one or more data sources from which the input data is received may include one or more sensor devices or sensing systems. In accordance with some embodiments of this disclosure, at least one of the sensor devices or sensing systems (e.g., a distributed control system (DCS), a supervisory control and data acquisition (SCADA) system, etc.) is coupled to industrial equipment associated with the industrial operation. The industrial equipment may be installed or located in one or more facilities (e.g., plants) or other physical locations (e.g., geographical areas), for example. The industrial equipment may be coupled to the at least one control system that the operators interact with, for example. At least one of the sensor devices or sensing systems may be configured to measure output(s) of the industrial equipment and provide data indicative of the measured output(s) as the input data. The measured output(s) may be indicative of operator effectiveness in some embodiments. At least one of the sensor devices or sensing systems may additionally or alternatively be configured to visually and/or audibly monitor the operators for which operator variation analysis is provided in some embodiments. For example, at least one image capture device may be positioned proximate to the operators and/or the industrial equipment and be configured to monitor the operators and/or the industrial equipment. Image capture data from the at least one image capture device may be provided as the input data and used to determine operator variations in some embodiments. The one or more data sources may additionally or alternatively include plant databases of operator logs, overall equipment effectiveness and maintenance records, for example.

It is understood that the input data may come in a variety of forms and include (or not include) various types of information. For example, the input data may be received in digital form and include time series (e.g., timestamps) and/or alarm event data collected from at least one industrial process associated with the industrial operation in some instances. Additionally, the input data may be provided in analog form and include other types of information in other instances. In some embodiments in which the input data is provided in analog form, the analog input data may be converted to digital input data (e.g., though use of one or more analog-to-digital conversion devices or means).

In accordance with some embodiments of this disclosure, the input data includes at least one of steady state process data, transient or non-steady state process data, and downtime data. The steady state process data may correspond, for example, to process data that does not change or changes only negligibly over a particular period of time. The amount of change (e.g., to be considered negligible) and the particular period of time may depend, for example, on the dynamics of the process or processes associated with the industrial operation. The transient or non-steady state process data may correspond, for example, to process data that changes by a statistically significant value or amount over a particular period of time. The statistically significant value or amount and the particular period of time may depend, for example, on the dynamics of the process or processes associated with the industrial operation. The downtime data may include, for example, information relating to planned and/or unplanned equipment outages, planned and/or unplanned process shutdowns, etc. In accordance with some embodiments of this disclosure, the input data may additionally or alternatively include alarms, recorded operator actions and/or recorded operator navigation on a DCS, SCADA system, or other control system in the industrial operation, for example.

In accordance with some embodiments of this disclosure, the data repository built for benchmarking/analytics (e.g., using the above-discussed input data) includes control system measurements and actions. In accordance with some embodiments of this disclosure, the control system measurements and actions include one or more of: time in automatic control mode, time in Advanced Process Control (APC) mode, interventions by operators that can be defined as optimizing vs. random adjustment, operator interventions per alarm, time to intervene in an alarm situation, operator time to configuration process loops and control elements, automatic versus manual transitions to a process, operator time to make tuning changes, number of alarm changes made by operators that deviate from designed level, Human-Machine Interface (HMI) graphics metrics such as number of graphics viewed, time on a graphic, transitions between graphics, operator experience with a graphic, energy usage per production unit, production output, number of notifications/email from outside sources and number of communications with field personnel.

In accordance with some embodiments of this disclosure, the data repository additionally or alternatively includes analytical or calculated data. In accordance with some embodiments of this disclosure, the analytical or calculated data includes one or more of: shift to shift variation, shift hour variation, shift transition variation, fatigue: day vs night, Control room survey, Operator span of control, definition of normal operation, biases, quality or selectivity, and fatigue. In accordance with some embodiments of this disclosure, the data repository is used as a tool to compare operator effectiveness in various industries within individual plants or between similar units at a plant.

As noted above, biggest contributors of operator variability may be identified based on an analysis of the data repository. In accordance with some embodiments of this disclosure, the biggest contributors of operator variability may be further identified based on an analysis of information from one or more other systems or devices associated with the industrial operation. The other systems or devices (sensor devices, databases, etc.) may be local or remote devices. For example, the other systems or devices may include a user device from which a user (e.g., supervisor or co-worker of operator(s)) may provide user input data (e.g., information relating to operator effectiveness). The other systems or devices may also include a cloud-connected device or database from which additional information (e.g., additional information associated with the industrial operation) may be retrieved or provided.

In accordance with some embodiments of this disclosure, impacts of the identified biggest contributors of operator variability on the industrial operation may be determined using the above method. For example, tangible (e.g., monetary) costs and/or intangible (e.g., reputation) costs associated with the identified biggest contributors of operator variability may be used to determine the impacts of the identified biggest contributors of operator variability. In accordance with some embodiments of this disclosure, the identified biggest contributors of operator variability may be prioritized based on the determined impacts. Additionally, the one or more actions taken to reduce or eliminate the biggest contributors of operator variability may be performed based, at least in part, on the prioritization. The one or more actions taken to reduce or eliminate the biggest contributors of operator variability may include, for example, recommending specific automation, operator tools or modernization to reduce impact of the biggest contributors of operator variability on the industrial operation. In accordance with some embodiments of this disclosure, once the one or more actions are taken or implemented, the method is repeated to identify the next biggest improvement gap or priority. This is all based on data and specific analytic methods applied on the data. As illustrated above, the method enables and drives a continuous improvement process.

In accordance with some embodiments of this disclosure, the different types of data in the input data (e.g., steady state process data, transient or non-steady state process data, downtime data, etc.) may be separated and a select type (or select types) of the data) may be analyzed to determine a “best” operator (e.g., for measuring/determining operator effectiveness). In accordance with some embodiments of this disclosure, the separated or select types of data correspond to data associated with one or more regimes of operation associated with the industrial operation. As used herein, a regime of operation refers to a same or similar condition in the industrial operation. It is understood that an industrial operation may include multiple distinct regimes of operation in some instances, with the distinct regimes of operation occurring, for example, due to physical differences in the industrial operation. The physical differences in the industrial operation may be due, for example, to non-human root causes. The non-human root causes may include, for example, equipment, process, ambient and/or market root causes. For example, a different feedstock, different product mix, different season, different equipment performance, different production rates and so on. In accordance with embodiments of this disclosure, human root causes are not distinct and are left in the data to be analyzed specifically for patterns in subsequent steps of the disclosed invention.

In one embodiment, the distinct regimes of operation may include a pulp and paper mill that makes dozens of different product grades of paper (i.e., example distinct products) based on the thickness, tensile strength or fiber length, and polymer unit (which may make multiple different grades of polypropylene based on density and melt index, for example). Each of these different grades or products will correspond to different operating conditions and/or raw materials. Another example of a distinct regime of operation is in a refinery that operates differently in summer compared with winter due to the difference in cooling water temperature and efficiency of heat transfer. These different conditions are non-human root causes and need to be analyzed independently for operator variation. It is to be understood that the reason for the clustering is to identify similar modes or regimes of operation so that the comparison of operator to operator eliminates the non-human root causes such as a different product, different season or different level of equipment performance.

Additional aspects relating to the process of separating the data (e.g., into different regimes of operation), identifying/determining the best operator and other aspects of the disclosed invention will appreciated from further discussion below, and from co-pending U.S. patent applications entitled “Systems and methods for providing operator variation analysis for transient operation of continuous or batch wise continuous processes”, “Systems and methods for providing operator variation analysis for steady state operation of continuous or batch wise continuous processes”, and “Systems and methods for addressing gaps in an industrial operation due to operator variability”, which applications were filed on the same day as the present application, claim priority to the same provisional application as the present application, and are assigned to the same assignee as the present application. These applications are incorporated by reference herein in their entireties.

It is understood that the above-discussed method may include many other additional features, as will be appreciated by one of ordinary skill in the art.

In accordance with some embodiments of this disclosure, the above method (and/or other systems and methods disclosed herein) may be implemented using one or more systems or devices associated with the industrial operation. The one or more systems or devices may include systems or devices local to the industrial operation in some embodiments. For example, the one or more systems or devices may include an on-site server and/or an on-site monitoring system or device. The one or more systems or devices may also include systems or devices remote from the industrial operation in some embodiments. For example, the one or more systems or devices may include a gateway, a cloud-based system, a remote server, etc. (which may alternatively be referred to as a “head-end” or “edge” system herein).

The one or more systems or devices on which the above method (and/or other systems and methods disclosed herein) is implemented may include at least one processor and at least one memory device. As used herein, the term “processor” is used to describe an electronic circuit that performs a function, an operation, or a sequence of operations. The function, operation, or sequence of operations can be hard coded into the electronic circuit or soft coded by way of instructions held in a memory device. A processor can perform the function, operation, or sequence of operations using digital values or using analog signals.

In some embodiments, the processor can be embodied, for example, in a specially programmed microprocessor, a digital signal processor (DSP), or an application specific integrated circuit (ASIC), which can be an analog ASIC or a digital ASIC. Additionally, in some embodiments the processor can be embodied in configurable hardware such as field programmable gate arrays (FPGAs) or programmable logic arrays (PLAs). In some embodiments, the processor can also be embodied in a microprocessor with associated program memory. Furthermore, in some embodiments the processor can be embodied in a discrete electronic circuit, which can be an analog circuit, a digital circuit or a combination of an analog circuit and a digital circuit. The processor may be coupled to at least one memory device, with the processor and the at least one memory device configured to implement the above-discussed method. The at least one memory device may include a local memory device (e.g., EEPROM) and/or a remote memory device (e.g., cloud-based storage), for example.

It is understood that the terms “processor” and “controller” may be used interchangeably herein. For example, a processor may be used to describe a controller. Additionally, a controller may be used to describe a processor.

A system for benchmarking operator performance for an industrial operation is also provided herein. In one aspect of this disclosure, a system for benchmarking operator performance includes at least one processor and at least one memory device coupled to the at least one processor. The at least one processor and the at least one memory device are configured to receive input data relating to an industrial operation from one or more data sources, and process the input data to measure operator effectiveness and build a data repository for benchmarking/analytics. The data repository may include information relating to the measured operator effectiveness, for example. Biggest contributors of operator variability may be identified based on an analysis of the data repository, and one or more actions may be taken to reduce or eliminate the biggest contributors of operator variability.

Information relating to the measured operator effectiveness, biggest contributors of operator variability, etc. may be communicated in some instances, for example, on a display device and/or speaker associated with the above system and/or on one or more systems or devices (e.g., mobile devices) coupled to the above system. The information may include, for example, predicted economic benefits and/or production gains by addressing the biggest contributors of operator variability (e.g., via one or more solutions), and/or costs associated with addressing the biggest contributors of operator variability (e.g., via the one or more solutions).

In some instances, the one or more data sources from which the input data is received may include one or more sensor devices or sensing systems, such as those discussed earlier in this disclosure. In some instances, the above system includes or is coupled to the one or more data sources.

Other example aspects and features relating to analyzing operator performance are also disclosed herein, for example, to address gaps associated with operator performance (e.g., based on or in response the above and/or below discussed benchmarking). For example, in one aspect of this disclosure, a method for addressing gaps in an industrial operation due to operator variability is provided. The method includes processing input data received from one or more data sources to identify a best operator of a plurality of operators responsible for managing the industrial operation, for example, based on an evaluation of measured operator effectiveness (as discussed above in connection with the earlier disclosed method). In accordance with some embodiments of this disclosure, the operator with the best economic operation (e.g., greatest production amount, lowest costs and greatest production amount, least amount of waste, least amount of alarms, etc.) may be established/identified as the best operator. For example, the best operator may be determined by the best operating/economic KPI (usually production) for each steady state and transient regime of operation. Each cluster or regime may be treated independently in this analysis, for example. Therefore, it is possible to have several best operators in a one year period.

Subsequent to identifying the best operator (e.g., for each regime of operation), it may be determined if one or more gaps (e.g., produced from or associated with biggest contributors of operator variability) exist in the economic operation of the industrial operation due to operator variability between the best operator and operators other than the best operator. For example, select information associated with operators other than the best operator may be compared to select information associated with the best operator to determine if one or more gaps exist in the economic operation of the industrial operation due to operator variability between the best operator and operators other than the best operator. In accordance with some embodiments of this disclosure, the one or more gaps refer to or include the aggregate gap between the best operator and all other operators in each regime of operation and also the aggregated weighted sum of all gaps. The operator variability refers to a measure of the gap as a percentage. For example, if production is being used as the economic KPI, if the average gap between all operators and the best operator (operator with the highest production in a particular regime) is 1000 tons/day and the best operator production is 50,000 tons/day, the variability measure is 2%. This is also the potential increase in production if all operators performed the same as the best operator.

In response to determining one or more gaps exist in the economic operation of the industrial operation, the one or more gaps may be analyzed to determine if relevant characteristics associated with the one or more gaps justify at least one solution for addressing the one or more gaps for the particular industrial operation. In response to determining relevant characteristics associated with the one or more gaps justify at least one solution for addressing the one or more gaps for the particular industrial operation, the at least one solution may be identified and mapped to the one or more gaps.

Information relating to the at least one identified solution may be communicated in some instances, for example, on a display device and/or speaker associated with a system and/or a device (e.g., processing device) on which the method is implemented. The information may include, for example, predicted economic benefits and/or production gains by implementing the at least one identified solution, and/or costs associated with implementing the at least one identified solution. Additionally, the information may include relevant information relating to the mapping of the at least one identified solution to the one or more gaps. In some embodiments, one or more of the at least one identified solution may be selected and implemented to address the one or more gaps.

Other variations of systems and methods in accordance with embodiments of this disclosure are of course possible, as will be further appreciated from discussions below. As will also be appreciated from discussions below, the disclosed systems and methods may systematically improve operator performance in a number of ways. For example, the disclosed systems and methods may improve operator performance by:
Collecting relevant information/data from process unit(s) associated with process operator(s), for example, alarms, all operator electronically recorded actions on a distributed control system (DCS), real time process data, configuration changes, shift calendar, and so forth.
Objectively calculating operator performance or effectiveness by analyzing the variation between operators and shifts with data analytics, machine learning and clustering.
Establishing a central repository of operator performance metrics and compute benchmarks.
Determining specific operator performance gaps that have the biggest impact on process key performance indicators (KPIs).
Recommending specific solutions to improve operator performance. These solutions could be software or procedural changes.

Currently there are more than one hundred offers to aid the operator in operating processes, for example, in an industrial operation. However, there is no data based objective way to justify the operator tool or aid. There is also no clear way to measure the impact the operator tool has on the processes. This is one of the main reasons that the use of situational awareness guidelines is not as widespread as it could be. As noted in the Background section of this disclosure, it is estimated that collectively across the process industry $80B per year is lost due to human (i.e., operator) root causes. The systems and methods disclosed herein seek to reduce these losses and increase efficiencies.

While the examples provided herein are discussed with reference to an industrial operation, it is understood that the systems and methods disclosed herein are applicable to other types of operations in which it is desirable to monitor and manage operator performance.

It is also understood that there are many other features and advantages associated with the disclosed systems and methods, as will be appreciated from the discussions below.

### BRIEF DESCRIPTION OF THE DRAWINGS

The foregoing features of the disclosure, as well as the disclosure itself may be more fully understood from the following detailed description of the drawings, in which:

FIG. 1 shows an example industrial operation in accordance with embodiments of the disclosure;

FIGS. 2-2C illustrate an example need for the present invention;

FIG. 3 shows an example system in which operator performance may be monitored and managed in accordance with embodiments of this disclosure;

FIG. 4 is a flowchart illustrating an example implementation of a method for monitoring and managing operator performance;

FIG. 5 is a flowchart illustrating an example implementation of a method for addressing gaps in an industrial operation due to operator variability;

FIG. 6 shows example features in accordance with embodiments of this disclosure;

FIG. 7 shows example features in accordance with embodiments of this disclosure;

FIG. 8 is a flowchart illustrating an example implementation of a method for analyzing and prioritizing gaps in an economic operation of an industrial operation;

FIG. 9 is a flowchart illustrating an example implementation of a method for identifying, organizing and prioritizing solutions for addressing gaps in an economic operation of an industrial operation;

FIG. 10 shows an example mapping of solutions to address gaps in accordance with embodiments of this disclosure; and

FIG. 11 shows example best practices and considerations for addressing gaps in accordance with embodiments of this disclosure.

### DETAILED DESCRIPTION

The features and other details of the concepts, systems, and techniques sought to be protected herein will now be more particularly described. It will be understood that any specific embodiments described herein are shown by way of illustration and not as limitations of the disclosure and the concepts described herein. Features of the subject matter described herein can be employed in various embodiments without departing from the scope of the concepts sought to be protected.

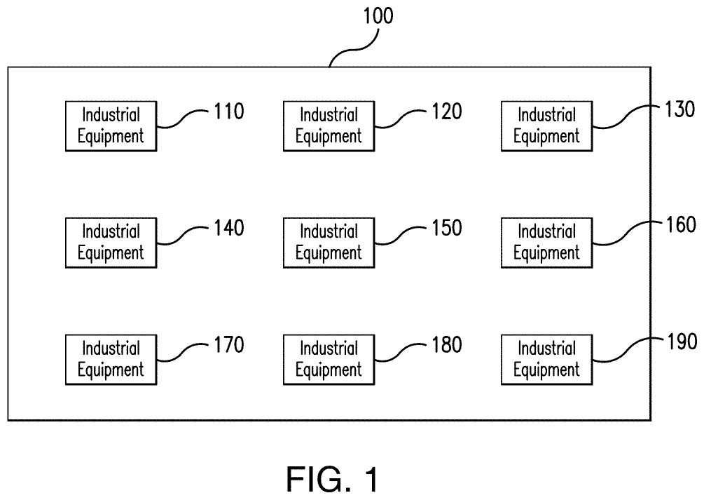

Referring to FIG. 1, an example industrial operation 100 in accordance with embodiments of the disclosure includes a plurality of industrial equipment 110, 120, 130, 140, 150, 160, 170, 180, 190. The industrial equipment (or devices) 110, 120, 130, 140, 150, 160, 170, 180, 190 may be associated with a particular application (e.g., an industrial application), applications, and/or process(es). The industrial equipment 110, 120, 130, 140, 150, 160, 170, 180, 190 may include electrical or electronic equipment, for example, such as machinery associated with the industrial operation 100 (e.g., a manufacturing or natural resource extraction operation). The industrial equipment 110, 120, 130, 140, 150, 160, 170, 180, 190 may also include the controls and/or ancillary equipment associated with the industrial operation 100, for example, process control and monitoring measurement devices. In embodiments, the industrial equipment 110, 120, 130, 140, 150, 160, 170, 180, 190 may be installed or located in one or more facilities (i.e., buildings) or other physical locations (i.e., sites) associated with the industrial operation 100. The facilities may correspond, for example, to industrial buildings or plants. Additionally, the physical locations may correspond, for example, to geographical areas or locations.

The industrial equipment 110, 120, 130, 140, 150, 160, 170, 180, 190 may each be configured to perform one or more tasks in some embodiments. For example, at least one of the industrial equipment 110, 120, 130, 140, 150, 160, 170, 180, 190 may be configured to produce or process one or more products, or a portion of a product, associated with the industrial operation 100. Additionally, at least one of the industrial equipment 110, 120, 130, 140, 150, 160, 170, 180, 190 may be configured to sense or monitor one or more parameters (e.g., industrial parameters) associated with the industrial operation 100. For example, industrial equipment 110 may include or be coupled to a temperature sensor configured to sense temperature(s) associated with the industrial equipment 110, for example, ambient temperature proximate to the industrial equipment 110, temperature of a process associated with the industrial equipment 110, temperature of a product produced by the industrial equipment 110, etc. The industrial equipment 110 may additionally or alternatively include one or more pressure sensors, flow sensors, level sensors, vibration sensors and/or any number of other sensors, for example, associated the application(s) or process(es) associated with the industrial equipment 110. The application(s) or process(es) may involve water, air, gas, electricity, steam, oil, etc. in one example embodiment.

The industrial equipment 110, 120, 130, 140, 150, 160, 170, 180, 190 may take various forms and may each have an associated complexity (or set of functional capabilities and/or features). For example, industrial equipment 110 may correspond to a “basic” industrial equipment, industrial equipment 120 may correspond to an “intermediate” industrial equipment, and industrial equipment 130 may correspond to an “advanced” industrial equipment. In such embodiments, intermediate industrial equipment 120 may have more functionality (e.g., measurement features and/or capabilities) than basic industrial equipment 110, and advanced industrial equipment 130 may have more functionality and/or features than intermediate industrial equipment 120. For example, in embodiments industrial equipment 110 (e.g., industrial equipment with basic capabilities and/or features) may be capable of monitoring one or more first characteristics of an industrial process, and industrial equipment 130 (e.g., industrial equipment with advanced capabilities) may be capable of monitoring one or more second characteristics of the industrial process, with the second characteristics including the first characteristics and one or more additional parameters. It is understood that this example is for illustrative purposes only, and likewise in some embodiments the industrial equipment 110, 120, 130, etc. may each have independent functionality.

As discussed in the Background section of this disclosure, industrial equipment (e.g., 110, 120, 130, etc.) is typically operated by, or at least monitored by, one or more system operators. As also discussed in the Background section of this disclosure, performance of the industrial equipment, and of the industrial operation (e.g., 100) associated with the industrial equipment, is often impacted by the system operators. For example, with system operator A, performance of the industrial equipment and the industrial operation may be at a level X. Additionally, with system operator B, performance of the industrial equipment and the industrial operation may be at a level Y. Further, with system operator C, performance of the industrial equipment and the industrial operation may be at a level Z.

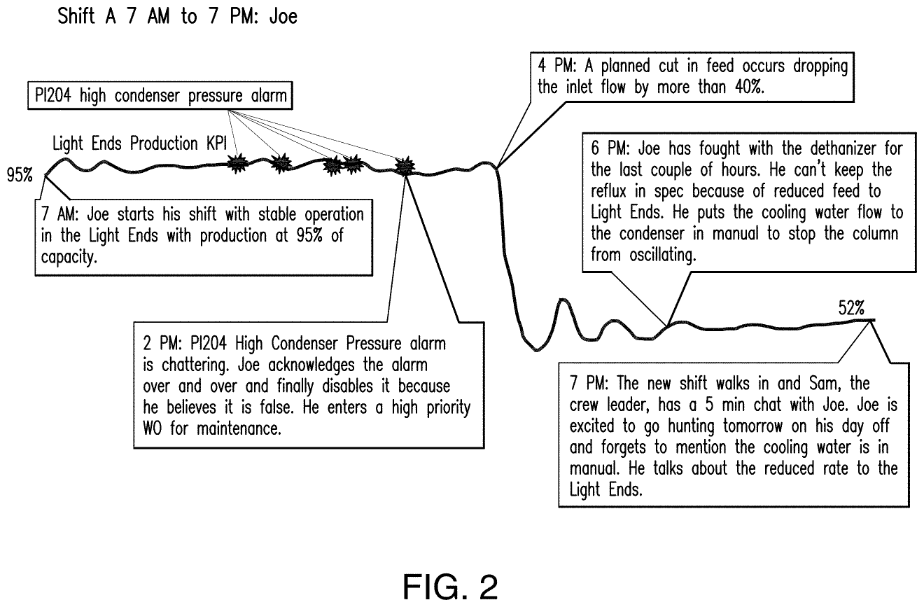

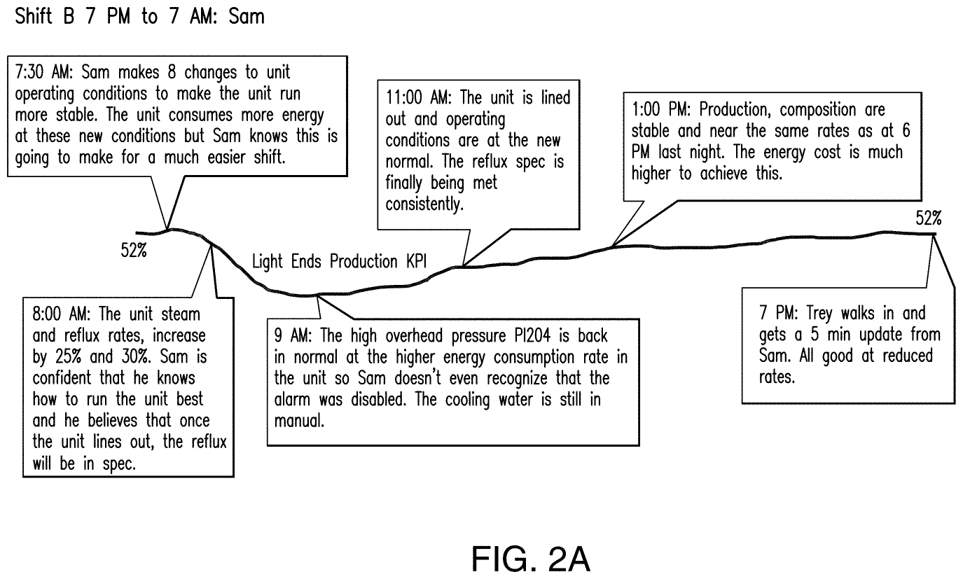

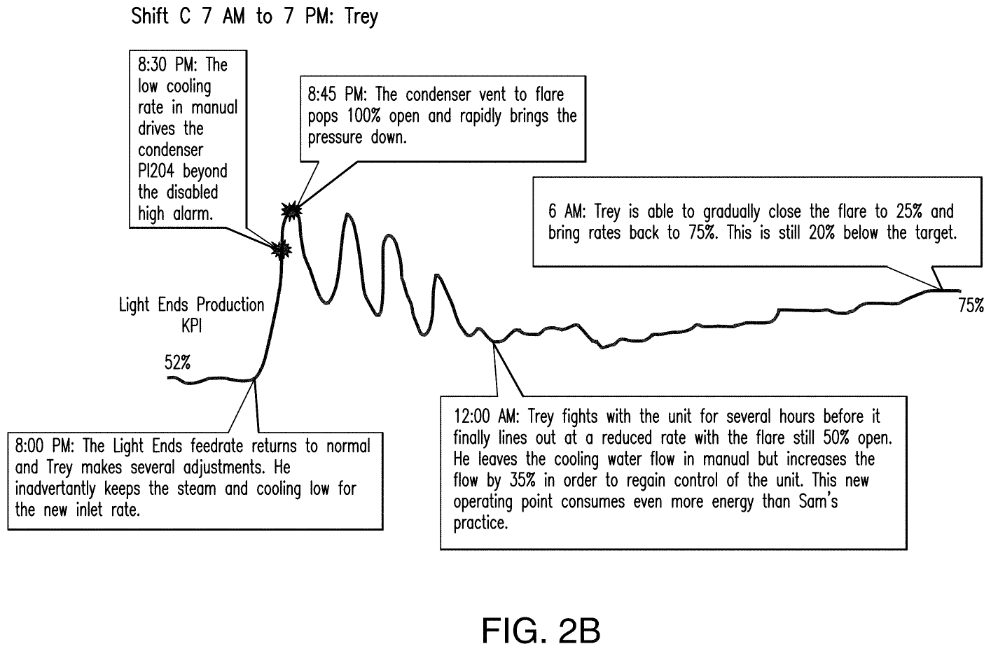

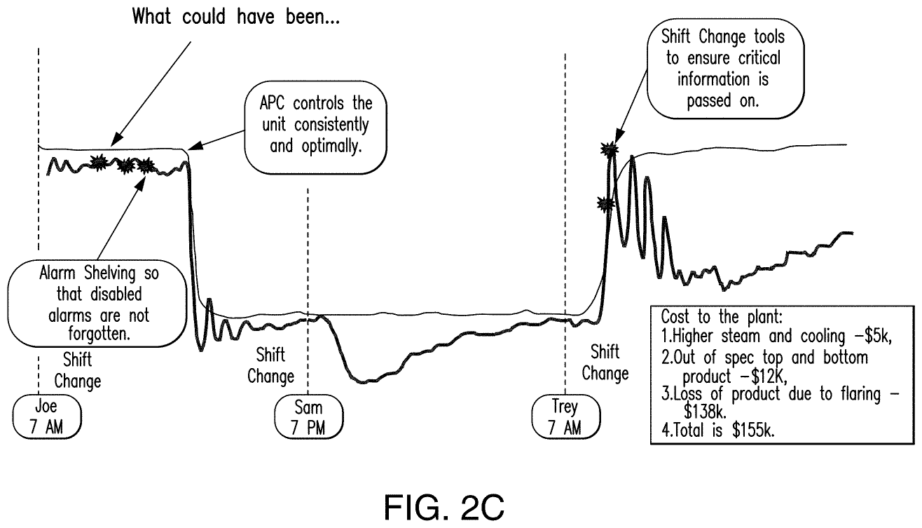

For example, referring now to FIGS. 2-2C, shown is a hypothetical in which there are three different operators (system operator A, system operator B, and system operator C) responsible for monitoring and managing a refinery (i.e., an example industrial operation). In the hypothetical, system operator A (e.g., “Joe”) monitors and manages the refinery over a first shift (as illustrated by FIG. 2), system operator B (e.g., “Sam”) monitors and manages the refinery over a second shift (as illustrated by FIG. 2A), and system operator C (e.g., “Trey”) monitors and manages the refinery over a third shift (as illustrated by FIG. 2B). As illustrated in FIGS. 2-2B, which show production key performance indicators (KPI) levels of the refinery when each of the system operators A, B, C is monitoring and managing the refinery, performance of the refinery varies between each of the of system operators A, B, C. As also illustrated in FIGS. 2-2B, performance of the refinery varies over the course of the shifts. A result of the foregoing is the refinery is not operating at its optimal level, as illustrated in FIG. 2C. This can significantly impact the operation's bottom line (i.e., tangible costs) and reputation (i.e., intangible costs). Accordingly, it is important to be able to accurately monitor and manage operator performance.

Provided herein are systems and methods for monitoring and managing operator performance, for example, to address at least the foregoing concerns.

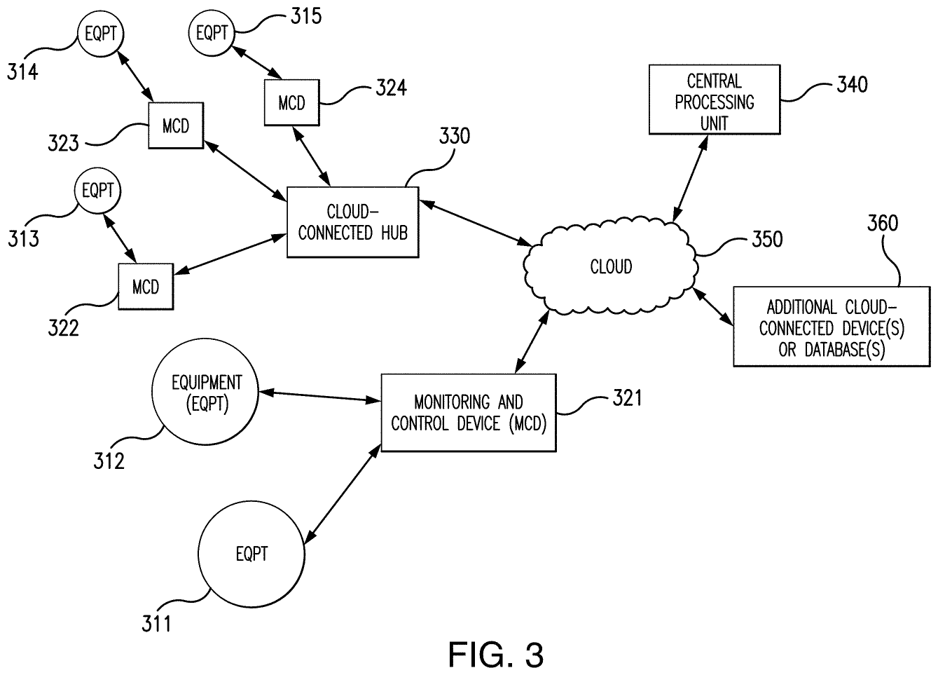

FIG. 3 illustrates aspects of an example system in which systems and methods in accordance with embodiments of this disclosure may be implemented. As illustrated in FIG. 3, the system includes a plurality of industrial equipment (here, equipment 311, 312, 313, 314, 315) and a plurality of monitoring and control devices (here, monitoring and control devices 321, 322, 323, 324) capable of monitoring and controlling one or more aspects of the equipment 311, 312, 313, 314, 315. The monitoring and control devices 321, 322, 323, 324 may also be capable of monitoring the operator(s) responsible for operating the equipment 311, 312, 313, 314, 315, as will be appreciated from discussions below. In accordance with some embodiments of this disclosure, the equipment 311, 312, 313, 314, 315 may be the same as or similar to the equipment 110, 120, 130, 140, 150, 160, 170, 180, 190 discussed above in connection with FIG. 1. For example, the equipment 311, 312, 313, 314, 315 may include electrical or electronic equipment, such as machinery associated with an industrial operation (e.g., 100, shown in FIG. 1).

As shown in FIG. 3, the monitoring and control devices 321, 322, 323, 324 are each associated with one or more of the equipment 311, 312, 313, 314, 315. For example, the monitoring and control devices 321, 322, 323, 324 may be coupled to one or more of the equipment 311, 312, 313, 314, 315 and may monitor and, in some embodiments, analyze parameters (e.g., process-related parameters) associated with the equipment 311, 312, 313, 314, 315 to which they are coupled. Additionally, the monitoring and control devices 321, 322, 323, 324 may be positioned proximate to the operator(s) responsible for operating the equipment 311, 312, 313, 314, 315, and be configured to monitor the operator(s). In accordance with some embodiments of this disclosure, the monitoring and control devices 321, 322, 323, 324 include at least one of a distributed control system (DCS) and a supervisory control and data acquisition (SCADA) system, for example, for monitoring and controlling the equipment 311, 312, 313, 314, 315. Additionally, in accordance with some embodiments of this disclosure, the monitoring and control devices 321, 322, 323, 324 include at least one visual and/or audible monitoring device, for example, for monitoring the equipment 311, 312, 313, 314, 315 and/or for monitoring the operator(s) responsible for operating the equipment 311, 312, 313, 314, 315. The at least one visual and/or audible monitoring device may include at least one image capture device, for example, a camera, in some embodiments. Additionally, the at least one visual and/or audible monitoring device may include at least one eye tracking device, for example, to observe how operator(s) engage with system(s), machine(s) and process(es). It is understood that other types of monitoring and control devices 321, 322, 323, 324 are, of course, possible for monitoring and controlling the equipment 311, 312, 313, 314, 315 and/or for monitoring the operator(s) responsible for operating the equipment 311, 312, 313, 314, 315.

In the example embodiment shown, the monitoring and control devices 321, 322, 323, 324 are communicatively coupled to a central processing unit 340 via the “cloud” 350. In some embodiments, the monitoring and control devices 321, 322, 323, 324 may be directly communicatively coupled to the cloud 350, as monitoring and control device 321 is in the illustrated embodiment. In other embodiments, the monitoring and control devices 321, 322, 323, 324 may be indirectly communicatively coupled to the cloud 350, for example, through an intermediate device, such as a cloud-connected hub 330 (or a gateway), as monitoring and control devices 322, 323, 324 are in the illustrated embodiment. The cloud-connected hub 330 (or the gateway) may, for example, provide the monitoring and control devices 322, 323, 324 with access to the cloud 350 and the central processing unit 340. It is understood that not all monitoring and control devices may have a connection with (or may be capable of connecting with) the cloud 350 (directly or non-directly). In embodiments is which a monitoring and control device is not connected with the cloud 350, the monitoring and control device may be communicating with a gateway, edge software or possibly no other devices (e.g., in embodiments in which the monitoring and control device is processing data locally).

As used herein, the terms “cloud” and “cloud computing” are intended to refer to computing resources connected to the Internet or otherwise accessible to monitoring and control devices 321, 322, 323, 324 via a communication network, which may be a wired or wireless network, or a combination of both. The computing resources comprising the cloud 350 may be centralized in a single location, distributed throughout multiple locations, or a combination of both. A cloud computing system may divide computing tasks amongst multiple racks, blades, processors, cores, controllers, nodes or other computational units in accordance with a particular cloud system architecture or programming. Similarly, a cloud computing system may store instructions and computational information in a centralized memory or storage, or may distribute such information amongst multiple storage or memory components. The cloud system may store multiple copies of instructions and computational information in redundant storage units, such as a RAID array.

The central processing unit 340 may be an example of a cloud computing system, or cloud-connected computing system. In embodiments, the central processing unit 340 may be a server located within buildings (or other locations) in which the equipment 311, 312, 313, 314, 315, and the monitoring and control devices 321, 322, 323, 324 are installed, or may be remotely-located cloud-based service. The central processing unit 340 may include computing functional components similar to those of the monitoring and control devices 321, 322, 323, 324 in some embodiments, but may generally possess greater numbers and/or more powerful versions of components involved in data processing, such as processors, memory, storage, interconnection mechanisms, etc. The central processing unit 340 can be configured to implement a variety of analysis techniques to identify patterns in received measurement data from the monitoring and control devices 321, 322, 323, 324, as discussed further below. The various analysis techniques discussed herein further involve the execution of one or more software functions, algorithms, instructions, applications, and parameters, which are stored on one or more sources of memory communicatively coupled to the central processing unit 340. In certain embodiments, the terms “function”, “algorithm”, “instruction”, “application”, or “parameter” may also refer to a hierarchy of functions, algorithms, instructions, applications, or parameters, respectively, operating in parallel and/or tandem. A hierarchy may comprise a tree-based hierarchy, such a binary tree, a tree having one or more child nodes descending from each parent node, or combinations thereof, wherein each node represents a specific function, algorithm, instruction, application, or parameter.

In embodiments, since the central processing unit 340 is connected to the cloud 350, it may access additional cloud-connected devices or databases 360 via the cloud 350. For example, the central processing unit 340 may access the Internet and receive other information that may be useful in analyzing data received from the monitoring and control devices 321, 322, 323, 324. In embodiments, the cloud-connected devices or databases 360 may correspond to a device or database associated with one or more external data sources. Additionally, in embodiments, the cloud-connected devices or databases 360 may correspond to a user device from which a user may provide user input data. A user may view information about the monitoring and control devices 321, 322, 323, 324 (e.g., monitoring and control device manufacturers, models, types, etc.) and data collected by the monitoring and control devices 321, 322, 323, 324 (e.g., information associated with the industrial operation) using the user device. Additionally, in embodiments the user may configure the monitoring and control devices 321, 322, 323, 324 using the user device.

In embodiments, by leveraging the cloud-connectivity and enhanced computing resources of the central processing unit 340 relative to the monitoring and control devices 321, 322, 323, 324, sophisticated analysis can be performed on data retrieved from one or more monitoring and control devices 321, 322, 323, 324, as well as on the additional sources of data discussed above, when appropriate. This analysis can be used to dynamically control one or more parameters, processes, conditions or equipment (e.g., equipment 311, 312, 313, 314, 315) associated with the industrial operation.

In embodiments, the parameters, processes, conditions or equipment are dynamically controlled by at least one control system associated with the industrial operation. In embodiments, the at least one control system may correspond to or include one or more of the monitoring and control devices 321, 322, 323, 324, central processing unit 340 and/or other devices associated with the industrial operation. As noted earlier in this disclosure, operators correspond to humans that interact with at least one control system associated with the industrial operation.

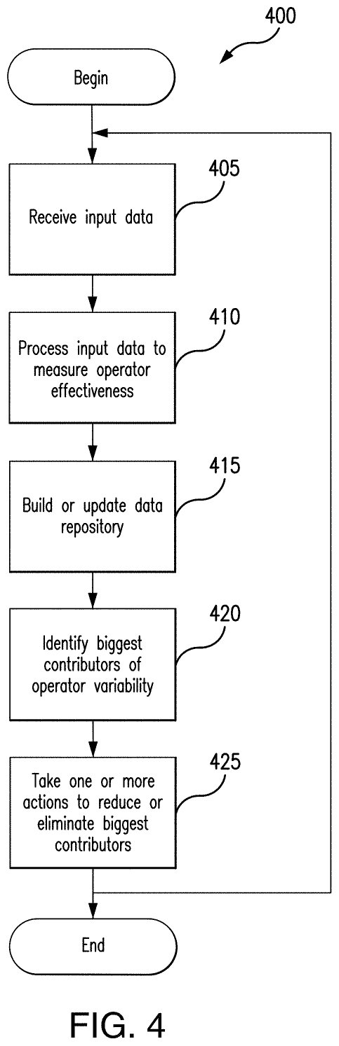

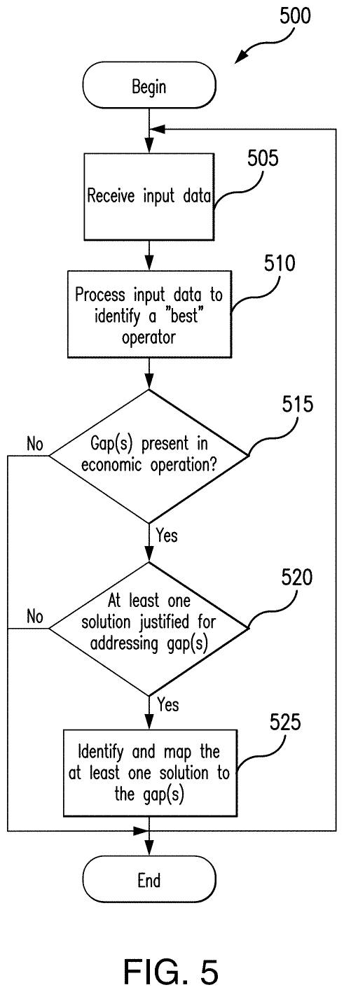

Referring to FIGS. 4-9, several flowcharts (or flow diagrams) and related figures are shown to illustrate various methods (here, methods 400, 500, 800, 900) of the disclosure relating to monitoring and managing operator performance. Rectangular elements (typified by element 405 in FIG. 4), as may be referred to herein as “processing blocks,” may represent computer software and/or algorithm instructions or groups of instructions. Diamond shaped elements (typified by element 515 in FIG. 5), as may be referred to herein as “decision blocks,” represent computer software and/or algorithm instructions, or groups of instructions, which affect the execution of the computer software and/or algorithm instructions represented by the processing blocks. The processing blocks and decision blocks (and other blocks shown) can represent steps performed by functionally equivalent circuits such as a digital signal processor (DSP) circuit or an application specific integrated circuit (ASIC).

The flowcharts do not depict the syntax of any particular programming language. Rather, the flowcharts illustrate the functional information one of ordinary skill in the art requires to fabricate circuits or to generate computer software to perform the processing required of the particular apparatus. It should be noted that many routine program elements, such as initialization of loops and variables and the use of temporary variables are not shown. It will be appreciated by those of ordinary skill in the art that unless otherwise indicated herein, the particular sequence of blocks described is illustrative only and can be varied. Thus, unless otherwise stated, the blocks described below are unordered; meaning that, when possible, the blocks can be performed in any convenient or desirable order including that sequential blocks can be performed simultaneously (e.g., run parallel on multiple processors and/or multiple systems or devices) and vice versa. Additionally, the order/flow of the blocks may be rearranged/interchanged in some cases as well. It will also be understood that various features from the flowcharts described below may be combined in some embodiments. Thus, unless otherwise stated, features from one of the flowcharts described below may be combined with features of other ones of the flowcharts described below, for example, to capture the various advantages and aspects of systems and methods associated with monitoring and managing operator performance sought to be protected by this disclosure. It is also understood that various features from the flowcharts described below may be separated in some embodiments. For example, while the flowcharts illustrated in FIGS. 4, 5, 8 and 9 are shown having many blocks, in some embodiments the illustrated method shown by these flowcharts may include fewer blocks or steps.

Referring to FIG. 4, a flowchart illustrates an example method 400 for monitoring and managing operator performance, for example, to better understand and minimize variations between operators. Method 400 may be implemented, for example, on at least one processor of at least one system and/or device associated with the system and/or operation in which operation performance is being monitored and managed. For example, method 400 may be implemented on at least one processor of at least one of monitoring and control devices 321, 322, 323, 324 and/or on at least one processor of central processing unit 340 shown in FIG. 3. It is understood that method 400 may be implemented on many other systems and/or devices.

As illustrated in FIG. 4, the method 400 begins at block 405, where input data relating to an industrial operation is received from one or more data sources. In accordance with some embodiments of this disclosure, the one or more data sources include one or more sensor devices or sensing systems. For example, the one or more data sources may include one or more sensor devices or sensing systems (e.g., monitoring and control devices 321, 322, 323, 324, shown in FIG. 3) coupled to industrial equipment (e.g., equipment 311, 312, 313, 314, 315, shown in FIG. 3) associated with the industrial operation. The one or more sensor devices or sensing systems may be configured to measure output(s) of the industrial equipment and provide the measured output(s), or data indicative of the measured output(s), as the input data at block 405. In accordance with some embodiments of this disclosure, the one or more data sources may additionally or alternatively include visual and/or audible monitoring devices. For example, at least one image capture device may be positioned proximate to operator(s) associated with the industrial operation and/or the industrial equipment and be configured to monitor the operator(s) and/or the industrial equipment. Image capture data from the at least one image capture device may be provided as the input data at block 405.

At block 410, the input data is processed to measure operator effectiveness. In accordance with some embodiments of this disclosure, output(s) of industrial equipment (which is an example type of input data) may be indicative of operator effectiveness. Operator effectiveness may also be measured or determined based on an evaluation of other types of input data, for example, user input data and data from other data sources (e.g., external data sources).

In accordance with some embodiments of this disclosure, the input data used for measuring operator effectiveness is parsed per industrial application associated with the industrial operation, and the operator effectiveness is separately measured for each industrial application. In some embodiments, each industrial application is associated with a different process or piece of equipment. Additionally, in some embodiments the industrial operation is associated with a plurality of sites (e.g., physical plant sites) and/or a plurality of customers (e.g., different customers). In these embodiments, the operator effectiveness may be measured for each of the plurality of sites alone or in combination with other sites of the plurality of sites.

In accordance with some embodiments of this disclosure, the input data is collected to a point where a data set produced from the input data is determined to be statistically significant. In accordance with some embodiments of this disclosure, the data set is analyzed to identify correlations between one or more metrics associated with the industrial operation. The one or more metrics may including, for example, at least one of: production rate stability, number of transitions between HMI graphics, number of loops in manual versus automatic, energy usage in kilowatts per unit, total time process loops are in manual vs automatic mode, total transitions from manual to automatic control of a process, tuning changes to control loops, count of alarm changes. In accordance with some embodiments of this disclosure, the one or more metrics are cross referenced with at least one of: shift time of day, shift length, shift manpower and experience levels of operators, to further identify the correlations. The one or more metrics may be analyzed, for example, using regression analyses and/or other analytics to identify the correlations. The correlations may be indicative of best practices at plants, for example, which may lead to key process indicators of operator effectiveness. In accordance with some embodiments of this disclosure, the operator actions are linked to at least one of the one or more metrics, and the linking is used, at least in part, to measure the operator effectiveness. For example, in one example implementation, operator actions can be linked to a variety of metrics and through a collection of metrics it will be shown that the metrics directly correlate to operator effectiveness. From this correlation, monetary losses and quality may be improved.

In accordance with some embodiments of this disclosure, the input data is “clustered”, for example, into its different regimes of operation, and the operator effectiveness is measured for each regime of operation (i.e., the analysis performed at block 410 is applied to each regime). Additional aspects relating to measuring operator effectiveness, for example, through clustering (e.g., to identify a “best” operator) is described further in connection with method 500 (e.g., at block 510), and also in co-pending U.S. patent applications entitled “Systems and methods for providing operator variation analysis for transient operation of continuous or batch wise continuous processes”, “Systems and methods for providing operator variation analysis for steady state operation of continuous or batch wise continuous processes”, and “Systems and methods for addressing gaps in an industrial operation due to operator variability”, which applications were filed on the same day as the present application, claim priority to the same provisional application as the present application, and are assigned to the same assignee as the present application. These applications are incorporated by reference herein in their entireties.

At block 415, a data repository is built (e.g., in embodiments in which a data repository does not already exist, cannot be updated, etc.) or updated (e.g., in embodiments in which a data repository already exists) for benchmarking/analytics. The data repository may include information relating to the measured/determined operator effectiveness. For example, in accordance with some embodiments of this disclosure, the data repository includes control system measurements and actions. The control system measurements and actions may include, for example, one or more of: time in automatic control mode, time in Advanced Process Control (APC) mode, interventions by operators that can be defined as optimizing vs. random adjustment, operator interventions per alarm, time to intervene in an alarm situation, operator time to configuration process loops and control elements, automatic versus manual transitions to a process, operator time to make tuning changes, number of alarm changes made by operators that deviate from designed level, Human-Machine Interface (HMI) graphics metrics such as number of graphics viewed, time on a graphic, transitions between graphics, operator experience with a graphic, energy usage per production unit, production output, number of notifications/email from outside sources and number of communications with field personnel.

In accordance with some embodiments of this disclosure, the data repository additionally or alternatively includes analytical or calculated data. The analytical or calculated data may include, for example, one or more of: shift to shift variation, shift hour variation, shift transition variation, fatigue: day vs night, Control room survey, Operator span of control, definition of normal operation, biases, quality or selectivity, and fatigue.

With respect to benchmarking, it is understood that benchmarking will significantly enhance the quality of the analysis and the recommendations provided in other blocks of this method and other methods disclosed herein. In accordance with some embodiments of this disclosure, the data repository is used as a tool to compare operator effectiveness in various industries within individual plants or between similar units at a plant.

It is understood that the data repository built or updated at block 415 may correspond to a local data repository (e.g., proximate to the industrial operation) or a remote data repository (e.g., a cloud-based data repository). The local data repository may be associated with monitoring and control devices, such as monitoring and control devices 321, 322, 323, 324 shown in FIG. 3, for example. Additionally, the remote data repository may be associated with cloud-computing resources, such as central processing unit 340 shown in FIG. 3, for example.

At block 420, biggest contributors of operator variability are identified based on an analysis of the data repository and/or other sources of data. The other sources of data may include one or more other systems or devices (sensor devices, databases, etc.) associated with the industrial operation, for example. The other systems or devices may be local or remote devices. For example, the other systems or devices may include a user device from which a user (e.g., supervisor or co-worker of operator(s)) may provide user input data (e.g., information relating to operator effectiveness). The other systems or devices may also include a cloud-connected device or database (e.g., 360, shown in FIG. 3) from which additional information (e.g., additional information associated with the industrial operation) may be retrieved or provided.

In accordance with some embodiments of this disclosure, the biggest contributors of operator variability may produce one or more gaps in the economic operation of the industrial operation. In accordance with some embodiments of this disclosure, the one or more gaps represent improvement potential during common process events or abnormal operation if all the variations between operators (i.e., all the variations between the best operator and the other operators) is removed. In accordance with some embodiments of this disclosure, the one or more gaps are gaps in production and/or profit between the best operator and all other operators. Additional aspects of example analysis that may be performed to identify the best operator and gaps are described further in connection with figures below, for example.

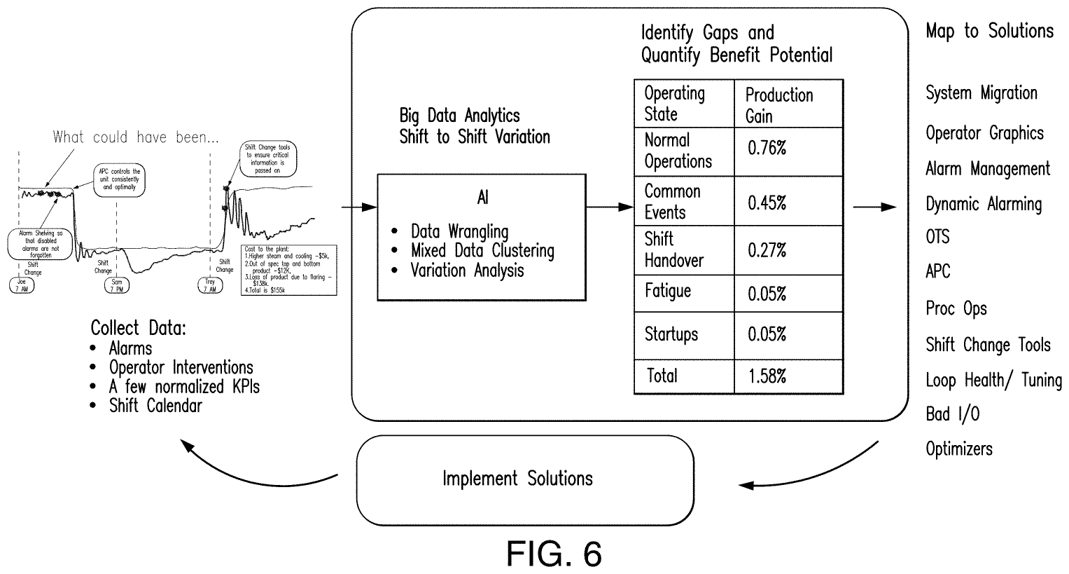

At block 425, one or more actions are taken to reduce or eliminate the biggest contributors of operator variability. In accordance with some embodiments of this disclosure, the one or more actions include recommending and/or implementing specific automation, operator tools or modernization (e.g., specific solutions, as shown in FIG. 6) to reduce impact of the biggest contributors of operator variability on the industrial operation. In recommending and/or implementing specific automation, for example, operator actions and judgement are reduced. Reducing operator variation combines reducing the number of actions (primarily) and making or encouraging their actions conform to each other. Further example actions that may be taken to reduce or eliminate the biggest contributors of operator variability will become further apparent from discussions below.

Subsequent to block 425, the method 400 may end in some embodiments. In other embodiments, the method 400 may return to block 405 and repeat again (e.g., for receiving additional input data). In some embodiments in which the method 400 ends after block 425, the method 400 may be initiated again automatically and/or in response to user input and/or a control signal, for example. For example, in some embodiments the method 400 may be repeated again automatically to identify and address (i.e., take actions to reduce or eliminate) a next biggest contributor of operator variability. In these embodiments, the method 400 may potentially be repeated again until all (or substantially all) of the biggest contributors of operator variability have been identified and addressed.

It is understood that method 400 may include one or more further blocks or steps in some embodiments, as will be apparent to one of ordinary skill in the art. For example, in some embodiments the method 400 may further include determining impacts of the identified biggest contributors of operator variability on the industrial operation. Additionally, in some embodiments the method 400 may further include prioritizing the identified biggest contributors of operator variability based on the determined impacts. In accordance with some embodiments of this disclosure, tangible costs and/or intangible costs associated with the identified biggest contributors of operator variability are used to determine the impacts of the identified biggest contributors of operator variability. Additionally, in accordance with some embodiments of this disclosure, the one or more actions taken at block 425 to reduce or eliminate the biggest contributors of operator variability are performed based, at least in part, on the prioritization of the identified biggest contributors of operator variability (e.g., based on the determined impacts). Additional aspects of determining the impacts (and other features) are described further after discussion of method 400, for example.

As illustrated above, method 400 enables and drives a continuous improvement process by identifying the biggest gap or priority in operator performance and recommending a specific solution to improve that aspect of performance. Additional aspects relating to monitoring and managing operator performance are described further in connection with figures below.

Referring to FIG. 5, a flowchart illustrates an example method 500 for addressing gaps in an industrial operation due to operator variability. In accordance with some embodiments of this disclosure, method 500 illustrates example steps that may be performed in one or more blocks of other methods disclosed herein (e.g., method 400) and/or in addition to the blocks of the other methods disclosed herein. Similar to other methods disclosed herein, method 500 may be implemented, for example, on at least one processor of at least one system or device associated with the industrial operation (e.g., 321, shown in FIG. 3) and/or remote from the industrial operation, for example, in at least one of: a cloud-based system, on-site software/edge, a gateway, or another head-end system.

As illustrated in FIG. 5, the method 500 begins at block 505, where input data relating to an industrial operation is received from one or more data sources. Similar to block 405 discussed above in connection with FIG. 4, in accordance with some embodiments of this disclosure, the one or more data sources include one or more sensor devices or sensing systems. For example, the one or more data sources may include one or more sensor devices or sensing systems (e.g., monitoring and control devices 321, 322, 323, 324, shown in FIG. 3) coupled to industrial equipment (e.g., equipment 311, 312, 313, 314, 315, shown in FIG. 3) associated with the industrial operation. Additionally, in accordance with some embodiments of this disclosure, the one or more data sources may further or alternatively include visual and/or audible monitoring devices. For example, at least one image capture device may be positioned proximate to operator(s) associated with the industrial operation and/or the industrial equipment and be configured to monitor the operator(s) and/or the industrial equipment. Image capture data from the at least one image capture device may be provided as the input data at block 505.

It is understood that the input data may come in a variety of forms and include (or not include) various types of information. For example, the input data may be received in digital form and include time series (e.g., timestamps) and/or alarm event data collected from at least one industrial process associated with the industrial operation in some instances. Additionally, the input data may be provided in analog form and include other types of information in other instances. In some embodiments in which the input data is provided in analog form, the analog input data may be converted to digital input data (e.g., though use of one or more analog-to-digital conversion devices or means). In accordance with some embodiments of this disclosure, the input data includes at least one of: real time data typically collected from the historian, laboratory data that is either entered automatically of manually, event data from alarms configured in a control system, event data from discrete operations such as motor start/stop which could be automatic or initiated from a human, and event data from human actions in the control system. It is understood that the input data may include many other types of data, as will be apparent to one of ordinary skill in the art.

At block 510, the input data is processed to identify a “best” operator of a plurality of operators responsible for managing the industrial operation. In accordance with some embodiments of this disclosure, the operator with the best economic operation (e.g., greatest production amount, lowest costs and greatest production amount, least amount of waste, least amount of alarms, etc.) may be established/identified as the best operator. In embodiments in which the plurality of operators are responsible for operating or controlling a same piece of equipment (or pieces of equipment) or a same process (or processes), for example, the best operator may be identified based on an analysis of the economic operation of the industrial operation when the plurality of operators (including the best operator) are operating or controlling the equipment or process(es). For example, equipment output(s), cost(s) and other information related to the economic operation may be analyzed to identify the best operator. In some embodiments, information relating to specific event(s) identified and tagged in data from or derived from the input data (e.g., operator action(s), or lack of operator action(s), in response to the specific event(s)) may be analyzed to identify the best operator.

In one example implementation of the disclosed invention, the input data may be processed at block 510 to identify transient or non-steady state process data relating to the industrial operation, and one or more types of data in the transient or non-steady state process data may be selected to cluster for operator variation analysis. The one or more types of selected data may be clustered using one or more data clustering techniques, and the clustered one or more types of data may be analyzed to identify the best operator of the plurality of operators responsible for managing the industrial operation. For example, the clustered data may be used to compare operator to operator variation and determine/identify the best operator. For example, within each cluster representing a specific event, the operator with the best economic operation may be established as the best operator. Additional aspects related to identifying transient or non-steady state process data and taking one or more steps using the transient or non-steady state process data to identify the best operator are discussed further in co-pending U.S. patent application entitled “Systems and methods for providing operator variation analysis for transient operation of continuous or batch wise continuous processes”, which application was filed on the same day as the present application, claims priority to the same provisional application as the present application, and is assigned to the same assignee as the present application. As noted above, this application incorporated by reference herein in its entirety.

In another example implementation of the disclosed invention, the input data may be processed at block 510 to identify steady state process data relating to the industrial operation, and distinct products and/or distinct regimes of operation associated with the steady state process data. The distinct products may correspond, for example, to products produced by the particular industrial operation. Additionally, the distinct regimes of operation (e.g., representing a same condition) may correspond to a pulp and paper mill, refinery, etc. in which the invention is implemented. For each of the identified distinct products and/or distinct regimes of operation, one or more types of data in the steady state process data may be selected to cluster for operator variation analysis, and the one or more types of selected data may be clustered for each of the identified distinct products and/or distinct regimes of operation using one or more data clustering techniques. The clustered one or more types of data may be analyzed for each of the identified distinct products and/or distinct regimes of operation, for example, to identify the best operator of the plurality of operators responsible for managing the industrial operation for the identified distinct products and/or distinct regimes of operation. Additional aspects related to identifying steady state process data and taking one or more steps using the steady state process data to identify the best operator are discussed further in co-pending U.S. patent application entitled “Systems and methods for providing operator variation analysis for steady state operation of continuous or batch wise continuous processes”, which application was filed on the same day as the present application, claims priority to the same provisional application as the present application, and is assigned to the same assignee as the present application. As noted above, this application is incorporated by reference herein in its entirety.

Other example methods for identifying the best operator will be apparent to one of ordinary skill in the art.

At block 515, it is determined if there are any gaps in the economic operation of the industrial operation. For example, select information associated with operators other than the best operator may be compared to select information associated with the best operator to determine if one or more gaps exist in the economic operation of the industrial operation due to operator variability between the best operator and the other operators. In accordance with some embodiments of this disclosure, the one or more gaps represent improvement potential during common process events or abnormal operation if all the variations between operators is removed. Additionally, the one or more gaps may be targets or motivations to apply additional or more effective automation.

Transient operation, for example, has the highest variability among operators due to the decisions and the timing of decisions they take. Factors that affect these decisions are primarily in the root cause analysis of the problem both in determining the root cause and the time taken to reach that conclusion. In a highly effective operating environment that is very intuitive, the conclusion and the time taken to reach it are very consistent among operators. Examples of select information associated with the operators that may be compared in an operating environment, for example, are the graphical displays at the overview, unit and equipment detail including the colors used in normal versus abnormal operation, alarms, trends and other information such as text alerts. Abnormal operation/situations may include a transition between products or grades, planned shut down or startup, planned equipment maintenance, equipment failure, raw material feed composition or rate change, upset in an upstream unit, upset in a downstream unit, change in catalyst activity. It is understood that many other types of information may correspond to the select information that may be compared between operators to determine if one or more gaps exist in the economic operation of the industrial operation.

At block 515, if it is determined if there are one or more gaps in the economic operation of the industrial operation, the method may proceed to block 520. Alternatively, if it is determined if there are no gaps in the economic operation of the industrial operation, the method may end or return to block 505 (e.g., for receiving new or additional input data) in some instances.

At block 520, relevant characteristics associated with the gap(s) are analyzed to determine if at least one solution is justified for addressing the gap(s) for the particular industrial operation. For example, a decision made by an operator different than the best operator or best practice that resulted in an impact to the operation such as lower production or off specification product quality (i.e., example gap(s)) may be analyzed to determine if at least one solution is justified for addressing the gap(s) for the particular industrial operation. In one example situation, it may be determined that the root cause of the incorrect decision was an ineffective/non intuitive operating environment that led to an incorrect root cause and an incorrect decision not the skill or experience of the operator. In this example situation, it may be determined that at least one solution is justified for addressing the gap(s) for the particular industrial operation, for example, to address the above-discussed root cause. It is understood that many example gaps and root causes may exist, and that what is justified for one particular industrial operation may not be the same for another industrial operation.

In accordance with some embodiments of this disclosure, the relevant characteristics analyzed at block 520 to make the determination include benefit potential by addressing the gap(s). For example, as illustrated in FIG. 6, subsequent to the data being collected and analyzed to identify the gap(s), the benefit potential by addressing the gap(s) may be quantified. For example, as illustrated in FIG. 6, the identified gap(s) may be associated with certain operating states (e.g., Normal Operations, Common Events, Shift Hangover, Fatigue, Startups, etc.) and the production gains (i.e., an example benefit potential) of addressing the gap(s) may be quantified. The production gains may be represented by percentages (e.g., percentage increase in production by addressing the gap(s)), quantities of goods (e.g., increase in quantity of goods by addressing the gap(s)), and in many other manners, as will be appreciated by one of ordinary skill in the art. While the production gains by addressing the gap(s) may only be a few percentages in some instances, it is understood that such increase in production on a very expensive process could be quite significant. For example, for a $100 million dollar process, the 1.58 percentage increase in production shown in FIG. 6 would amount to a $1.58 million dollar increase in production. It is understood that the production gains by addressing the gap(s) may be much more significant (e.g., close to or greater than a 10 percentage increase in production gains) in some instances. In some embodiments, the production gains and/or other benefits by addressing the gaps may factor into determining if at least one solution is justified for addressing the gap(s) for the particular industrial operation.

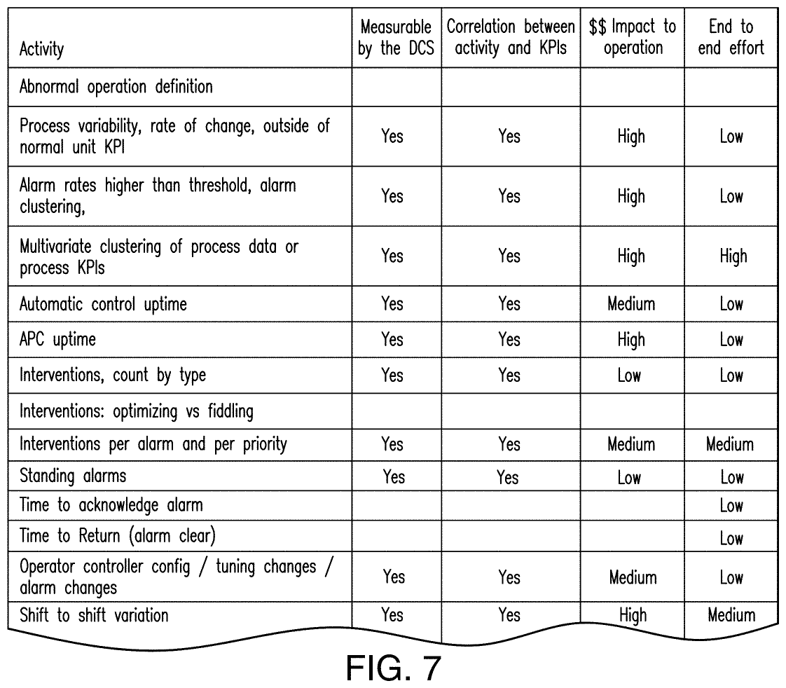

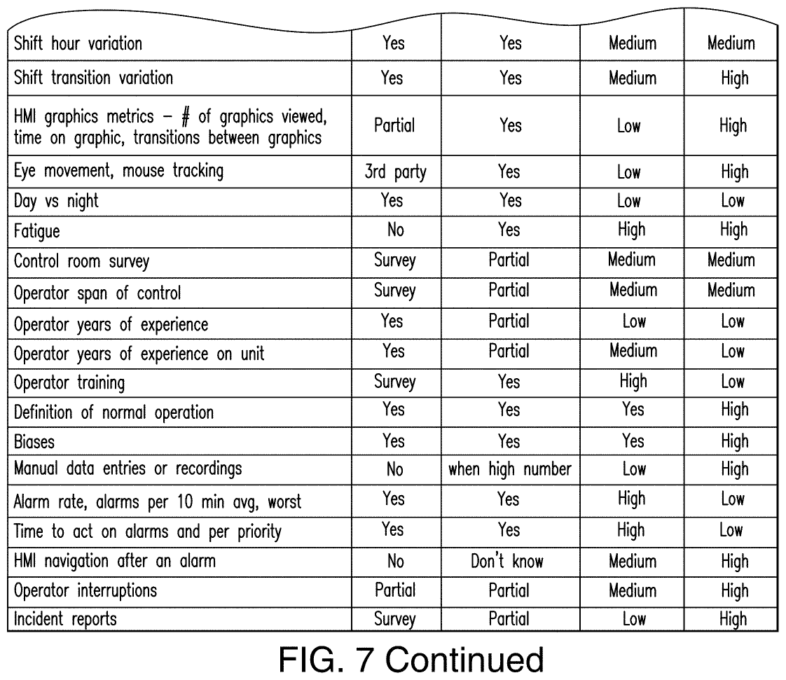

As further illustrated in FIG. 7, in addition to the gap(s) being identified and economic impact(s) of the gap(s) (e.g., cost(s) associated with the gap(s)) being determined, the gap(s) may be associated with certain activities/events, a correlation between the gap(s) and key performance indicators (KPIs) may be identified, and other types of information may be identified and provided. In some embodiments, this information may also factor into determining if at least one solution is justified for addressing the gap(s) for the particular industrial operation. It is understood that many other types of information may be collected, analyzed, and used to determine if at least one solution is justified for addressing the gap(s) for the particular industrial operation.

At block 520, if it is determined that relevant characteristics associated with the gap(s) justify at least one solution for addressing the gap(s) for the particular industrial operation, the method may proceed to block 525. Alternatively, if it is determined that relevant characteristics associated with the gap(s) do not justify at least one solution for addressing the gap(s) for the particular industrial operation, the method proceed to block 525, end, or return to block 505 (e.g., for receiving new or additional input data) in some instances.

At block 525, the at least one solution is identified and mapped to the gap(s). For example, as illustrated in FIG. 6, subsequent to the data being collected and analyzed to identify the gap(s), particular solutions for addressing the gap(s) may be identified and the gap(s) may be mapped to these solutions. These solutions may include software-based solutions, hardware-based solutions and many other types of solutions, as will be appreciated by one of ordinary skill in the art. For example, as illustrated in FIG. 6, the solutions or recommended solutions may include System Migration, Operator Graphics, Alarm Management, Dynamic Alarming, etc. For example, it may be recommended that Operator Graphics be changed or updated to improve operator performance in the industrial operation. Additionally, it may be recommended that one or more aspects of the operator environment (e.g., control room) be changed or updated to improve operator performance in the industrial operation. For example, it may be recommended that lighting in the operator environment be improved and specific recommendations for improving the lighting may be provided. Other examples of gaps that may be analyzed and addressed through the at least one identified solution include human traffic patterns through the control room, noise level(s), access to the operation(s) from the control room(s), access to the operating consoles of other process units (is the control room centralized or in separate buildings).

In accordance with some embodiments of this disclosure, information relating to the at least one identified solution and associated mapping map be communicated. For example, the information may include predicted economic benefits and/or production gains by implementing the at least one identified solution, and/or costs associated with implementing the at least one identified solution. In accordance with some embodiments of this disclosure, the information may be communicated via a report, text, email and/or audibly. The communication may occur or appear on one or more user devices, for example. The user devices may include a mobile device (e.g., phone, tablet, laptop) and other types of suitable devices (e.g., with displays, speakers, etc.) for the communication.

The at least one identified solution may include a plurality of solutions in some embodiments, for example, in instances in which a plurality of solutions exist for addressing the one or more gaps (e.g., as shown in FIG. 6). In these embodiments, the plurality of solutions may be organized and/or communicated in accordance with one or more user specified rules, for example. In accordance with some embodiments of this disclosure, the user specified rules may include one or more of: predicted economic benefits and/or production gains by implementing the at least one identified solution, costs associated with implementing the at least one identified solution, and time required to implement the at least one identified solution.

Subsequent to block 525, the method may end in some embodiments. In other embodiments, the method may return to block 505 and repeat again (e.g., for receiving and processing additional input data). In some embodiments in which the method ends after block 535, the method may be initiated again in response to user input, automatically, periodically, and/or a control signal, for example.

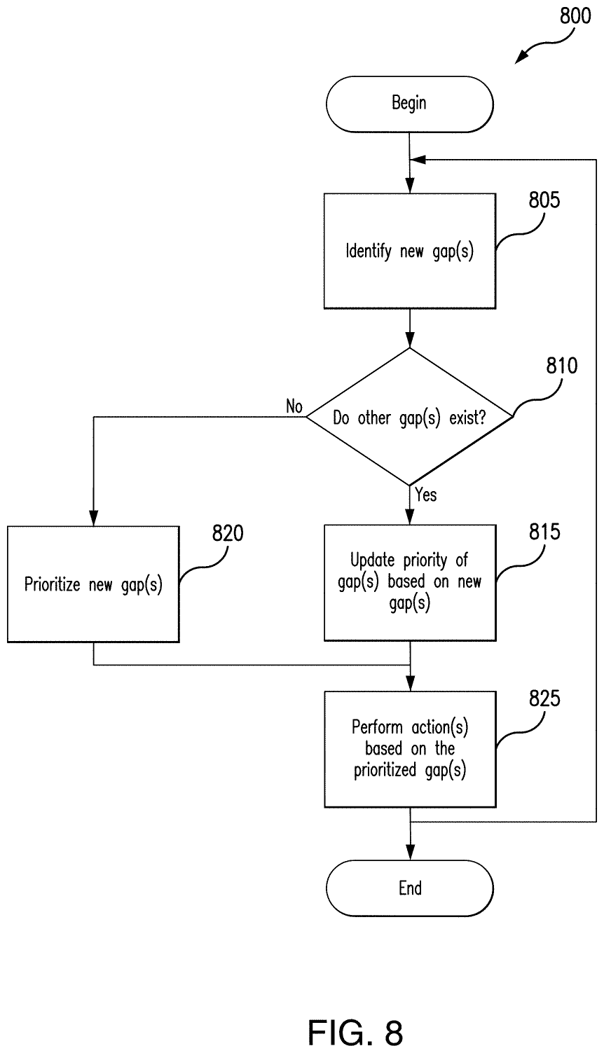

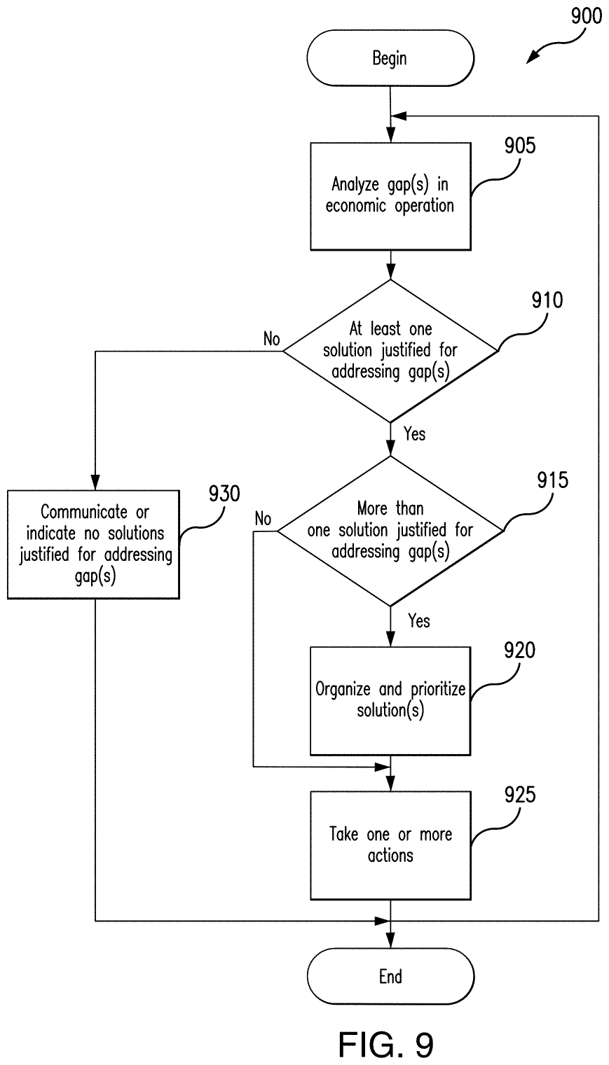

It is understood that method 500 may include one or more additional blocks or steps in some embodiments, as will be apparent to one of ordinary skill in the art. For example, in accordance with some embodiments of this disclosure, additional evaluations and actions may occur in the process indicated by method 500. Example additional evaluations and actions are discussed further in connection with FIGS. 8 and 9, for example.

Referring to FIG. 8, a flowchart illustrates an example method 800 for analyzing and prioritizing gaps in an economic operation of an industrial operation. In accordance with some embodiments of this disclosure, method 800 illustrates example steps that may be performed in one or more blocks of other methods disclosed herein (e.g., methods 400 and 500) and/or in addition to the blocks of the other methods disclosed herein. Similar to other methods disclosed herein, method 800 may be implemented, for example, on at least one processor of at least one system or device associated with the industrial operation (e.g., 321, shown in FIG. 3) and/or remote from the industrial operation, for example, in at least one of: a cloud-based system, on-site software/edge, a gateway, or another head-end system.

As illustrated in FIG. 8, the method 800 begins at block 805, where one or more new gaps in the economic operation of the industrial operation are identified. In accordance with some embodiments of this disclosure, the identified new gap(s) correspond to the gap(s) identified at block 530 of method 500 discussed above.

At block 810, it is determined if any other gap(s) exist in the economic operation of the industrial operation in addition to the new gap(s) identified at block 805. For example, as discussed above in connection with method 500, in some instances after block 515 in which no gap(s) are identified, or after block 525 in which at least one solution for addressing the gap(s) is identified and mapped to the gap(s), the method may return to block 505 for receiving and analyzing new or additional input data for identifying new or additional gap(s). In accordance with some embodiments of this disclosure, the other gap(s) in the economic operation analyzed/searched for in block 810 correspond to gap(s) potentially identified based on previous (e.g., older) input data.

At block 810, if it is determined that other gap(s) exist in the economic operation of the industrial operation in addition to the new gap(s) identified at block 805, the method may proceed to block 815. Alternatively, if it is determined that no other gap(s) exist in the economic operation of the industrial operation in addition to the new gap(s) identified at block 805, the method proceed to block 820.

At block 815, the priority of the gap(s) is/are adjusted based on the new gap(s) identified at block 805. In accordance with some embodiments of this disclosure, the gap(s) are is/are automatically organized and prioritized based on a number of factors. For example, the gap(s) may be organized (e.g., grouped) and prioritized based on economic costs (e.g., severity) of the gap(s) to the industrial operation, locations of the gap(s), types of the gap(s), activities associated with the gap(s) (e.g., as shown in FIG. 7), correlation between activities and KPIs (e.g., as shown in FIG. 7), and so forth. In some embodiments, gap(s) of greater severity, longer duration, and/or greater impact (e.g., $$ impact to operation, as shown in FIG. 7) may be prioritized higher. Alternatively, gap(s) that impact specific systems based on user configurations may be prioritized higher.

In accordance with some embodiments of this disclosure, a user or users (e.g., authorized user(s)) may configure the prioritization order and/or settings. For example, for some industrial operations, prioritization based on economic costs may be more important than types of the gap(s). In other industrial operations, prioritization based on the types of the gap(s) may be more important than economic costs. A balanced approach may also be adopted, for example, where gap prioritization is based on two or more factors (e.g., economic costs and types of the gap(s)). In some example implementations, as user or users may assign a weighting to each of these factors, with the weighting being used to determine the prioritization.

It is understood that the prioritization of the gap(s) for the particular industrial operation may change over time, for example, in response to new gap(s) being identified and/or in response to importance of the gap prioritization factors changing over time for the particular industrial operation. For example, at first point in time, one or more first gap prioritization factors (e.g., cost) may be more important than one or more second gap prioritization factors (e.g., type). Additionally, at a second point in time, the one or more second gap prioritization factors may be more important than the one or more first gap prioritization factors. In accordance with some embodiments of this disclosure, a reprioritization of gaps may occur automatically, for example, after a predetermined time period and/or in response to a user initiating a change in the gap prioritization factors. Additionally, in accordance with some embodiments of this disclosure, the reprioritization of gaps may occur manually, for example, in response to a user initiated action (e.g., button press or voice command). It is understood that many gap prioritization factors, and manners for prioritizing or reprioritizing, are of course possible, as will be appreciated by one of ordinary skill in the art.

Returning now to block 810, if it is determined that no other gap(s) exist in the economic operation of the industrial operation in addition to the new gap(s) identified at block 605, the method proceed to block 820. At block 820, the new gap(s) may be prioritized. In accordance with some embodiments of this disclosure, the new gap(s) are prioritized using one or more of the techniques discussed above in connection with block 815.

Subsequent to block 815 and/or block 820, one or more actions may be taken based on the prioritized gap(s) at block 825. For example, in accordance with some embodiments of this disclosure, the one or more actions may include communicating information relating to the prioritized gap(s). The communicated information may include, for example, information relating to the priority of the prioritized gap(s). The information may be communicated, for example, via a report, text, email and/or audibly. The report, text, email (i.e., visual communications) and/or audible communications may occur, for example, on at least one user device (e.g., of an industrial operation plant manager). For example, the report, text, email may be presented on at least one display device of the at least one user device, and the audible communications may be emitted through at least one speaker of the at least one user device.

Other example actions taken or performed based on or using the prioritized gap(s) may additionally or alternatively include storing information relating to the prioritized gap(s) (e.g., priority of the prioritized gap(s)) and determining if at least one solution is justified for addressing the gap(s) for the particular industrial operation. Additional aspects relating to determining if at least one solution is justified for addressing the gap(s) for the particular industrial operation are discussed further in connection with method 900 shown in FIG. 9, for example. Further example actions will be understood by one of ordinary skill in the art.

Subsequent to block 825, the method may end in some embodiments. In other embodiments, the method may return to block 805 and repeat again (e.g., for identifying new gap(s) in the economic operation). In some embodiments in which the method ends after block 825, the method may be initiated again in response to user input, automatically, periodically, and/or a control signal, for example.

Similar to methods discussed above, it is understood that method 800 may include one or more additional blocks or steps in some embodiments, as will be apparent to one of ordinary skill in the art.

Referring to FIG. 9, a flowchart illustrates an example method 900 for identifying, organizing and prioritizing solutions for addressing gaps in an economic operation of an industrial operation. In accordance with some embodiments of this disclosure, method 900 illustrates example steps that may be performed in one or more blocks of other methods disclosed herein (e.g., methods 400, 500, 800) and/or in addition to the blocks of the other methods disclosed herein. Similar to other methods disclosed herein, method 900 may be implemented, for example, on at least one processor of at least one system or device associated with the industrial operation (e.g., 321, shown in FIG. 3) and/or remote from the industrial operation, for example, in at least one of: a cloud-based system, on-site software/edge, a gateway, or another head-end system.

As illustrated in FIG. 9, the method 900 begins at block 905, where gap(s) in the economic operation of an industrial operation are analyzed. For example, in accordance with some embodiments of this disclosure, at block 905 information relating to gap(s) in the economic operation is received and analyzed. For example, similar to blocks 515, 520 and 525 discussed above in connection with FIG. 5, the gap(s) in the economic operation may be analyzed at block 905 to measure, quantify and/or characterize the gap(s).

At block 910, relevant characteristics associated with the gap(s) are analyzed to determine if at least one solution is justified for addressing the gap(s) for the particular industrial operation. For example, as discussed above in connection with FIG. 5, a decision made by an operator different than the best operator or best practice that resulted in an impact to the operation such as lower production or off specification product quality (i.e., example gap(s)) may be analyzed to determine if at least one solution is justified for addressing the gap(s) for the particular industrial operation. It is understood that many example gaps and root causes may exist, and that what is justified for one particular industrial operation may not be the same for another industrial operation.

At block 910, if it is determined that relevant characteristics associated with the gap(s) justify at least one solution for addressing the gap(s) for the particular industrial operation, the method may proceed to block 915. Alternatively, if it is determined that relevant characteristics associated with the gap(s) do not justify at least one solution for addressing the gap(s) for the particular industrial operation, the method proceed to block 930, end, or return to block 905 (e.g., for analyzing new or additional gap(s) in the economic operation) in some instances.

At block 915, in response to it being determined that relevant characteristics associated with the gap(s) justify at least one solution for addressing the gap(s) for the particular industrial operation, it is further determined if there is more than one solution justified for addressing the gap(s). If it is determined that there is more than one solution justified for addressing the gap(s), the method may proceed to block 920. Alternatively, if it is determined that there is not more than one solution justified for addressing the gap(s), the method may proceed to block 925.

At block 920, the solution(s) justified for addressing the gap(s) are organized and prioritized through a mapping process. In accordance with some embodiments of this disclosure, the solution(s) are automatically organized and prioritized based on a number of factors. For example, the solution(s) may be organized (e.g., grouped) and prioritized based on perceived or estimated effectiveness of the solution(s) (e.g., to provide most economic benefit to the industrial operation), costs associated with implementing the solution(s), end to end efforts of implementation the solution(s) (e.g., as shown in FIG. 7), severity(ies) of the gap(s) the solution(s) are addressing, location(s) of the gap(s), and so forth.

In accordance with some embodiments of this disclosure, a user or users (e.g., authorized user(s)) may configure the prioritization order and/or settings. For example, for some industrial operations, prioritization based on perceived or estimated effectiveness of the solution(s) may be more important than prioritization based on costs associated with implementing the solution(s). For these industrial operations, the solution(s) may be primarily (or exclusively) prioritized based on the perceived or estimated effectiveness of the solution(s). In other industrial operations, the severity(ies) of the gap(s) the solution(s) are addressing may be most important. For these industrial operations, the solution(s) may be primarily (or exclusively) prioritized based on the severity(ies) of the gap(s) the solution(s) are addressing. A balanced approach may also be adopted, for example, where prioritization is based on which solutions provide the most optimal combination of perceived or estimated effectiveness (e.g., greatest perceived or estimated effectiveness), implementation costs (e.g., lowest implementation costs), gap severity(ies) (e.g., address the highest severity gap(s)), location(s) of the gap(s) (e.g., address gap locations of greatest importance to the user(s) or operation(s)), and so forth. In some example implementations, as user or users may assign a weighting to each of these one or more factors, with the weighting being used to determine the prioritization.

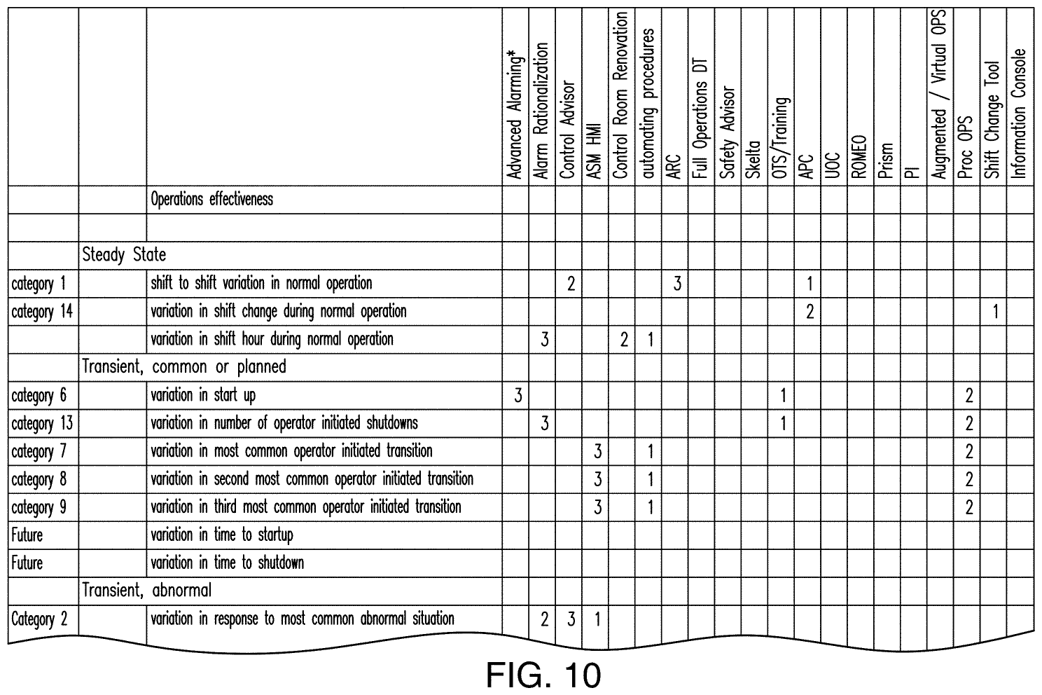

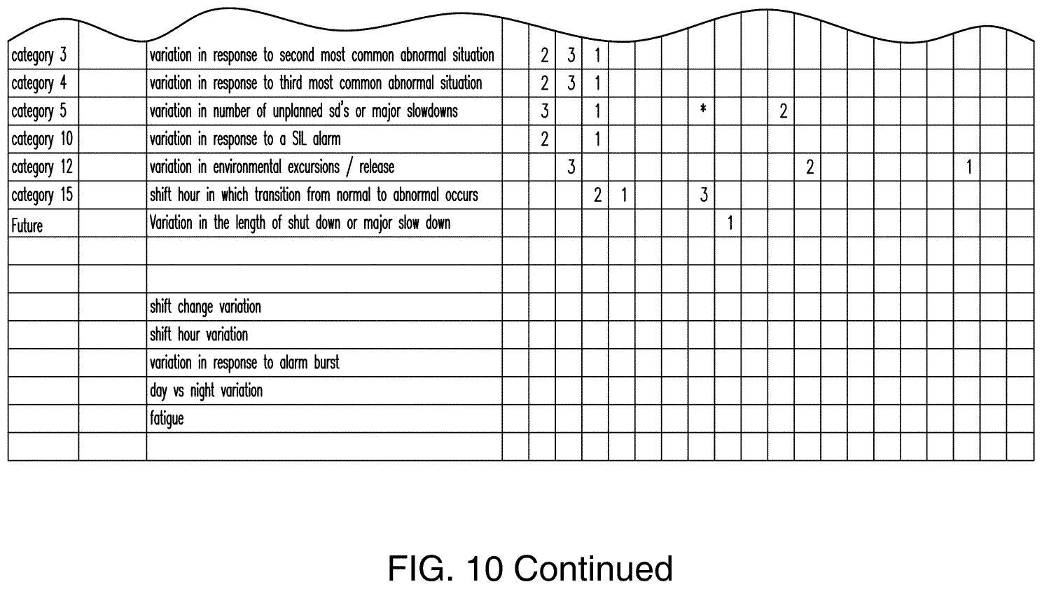

In one example implementation of the invention, each of the solution(s) identified as justified for addressing the gap(s) may be categorized and assigned a priority or ranking, for example, with highest priority solutions being noted with a ‘1’ and lower priority solutions being noted with a higher numbers (e.g., ‘2’, ‘3’, ‘4’, ‘5’, ‘6’, etc.). In accordance with some embodiments of this disclosure, the highest priority solutions correspond to the most optimal solutions (e.g., in terms of cost, perceived effectiveness, etc.) for addressing the gap(s). For example, as illustrated in FIG. 10, in the case of “shift to shift variation in normal operation” (same as operator variation), the highest/first priority solution (‘1’) is Advanced Process Control (APC), the second priority solution (‘2’) is Control Advisor, and the third priority solution (‘3’) is Advanced Regulatory Control (ARC). It is understood that these solutions (which are all currently offered by Schneider Electric, the assignee of the present application) are but a few of many possible solutions for this gap and other example gaps, as illustrated in FIG. 10. Additionally, while only three rankings or priorities are shown for the gaps shown in FIG. 10, it is understood that in some instances more than or less than three rankings or priorities may be assigned, for example, based on the number of possible or acceptable solutions for addressing the gaps.

Example mappings and justifications for mappings are described below for Steady State operation and Transient operation to provide further clarity on the example mapping process disclosed herein.

Steady State operation:

In normal Steady State operation, automatic control and optimization should generally be in control. There are multiple layers of automation that are generally accepted as the best practice in continuous processes. The base layer is single loop regulatory control, usually Proportional-Integral-Derivative (PID) controllers. If this control design is poor or insufficient, it could cause or force the operator to perform this task of monitoring process variables and making multiple changes in order to maintain Steady State operation. This is one failure mode and a primary reason for a large gap between operators in Steady State operation. One indication of this problem is high level of operator induced changes in Steady State operation. This is not an easy task and there will almost certainly be a high level of variation between the best operator and all other operators.

Even if the regulatory control is acceptable and operators do not have to perform this task, there is the optimization task. The goal of optimization is to make adjustments to the setpoints of regulatory loops in order to optimize profit. Usually production is maximized subject to several constraints. If this task is the responsibility of the operator, there will very likely be differences in the profitability of the operation and a significant gap between the best operator and other operators. Operators are commonly conservative in nature and are not comfortable operating near the many constraints of a complex industrial process. Advanced Process Control (APC) is specifically designed to perform this task continuously and safely. In a crude unit of a refinery for example, there can be over $5 Million dollars of profit of difference between optimization performed by operators and APC.

There are more opportunities (e.g., for improving operator performance and increasing profit by addressing gaps) in a Steady State operation, for example, with respect to shift change, fatigue, etc., as shown in FIG. 10.

Transient Operation:

In Transient operation, regulatory control and or APC are usually insufficient and the operator is often required to intervene. If there is an abnormal situation such as a single equipment failure, upstream upset, steam pressure upset, the operator must first understand what the root cause of the problem is and then determine the corrective actions. For this activity to be timely and correct, there are many potential solutions and best practices required. For example, with respect to “variation in response to most common abnormal situation”, this particular gap is mapped to ‘1’ high performance HMI, ‘2’ Alarm Rationalization and ‘3’ Control Advisor.

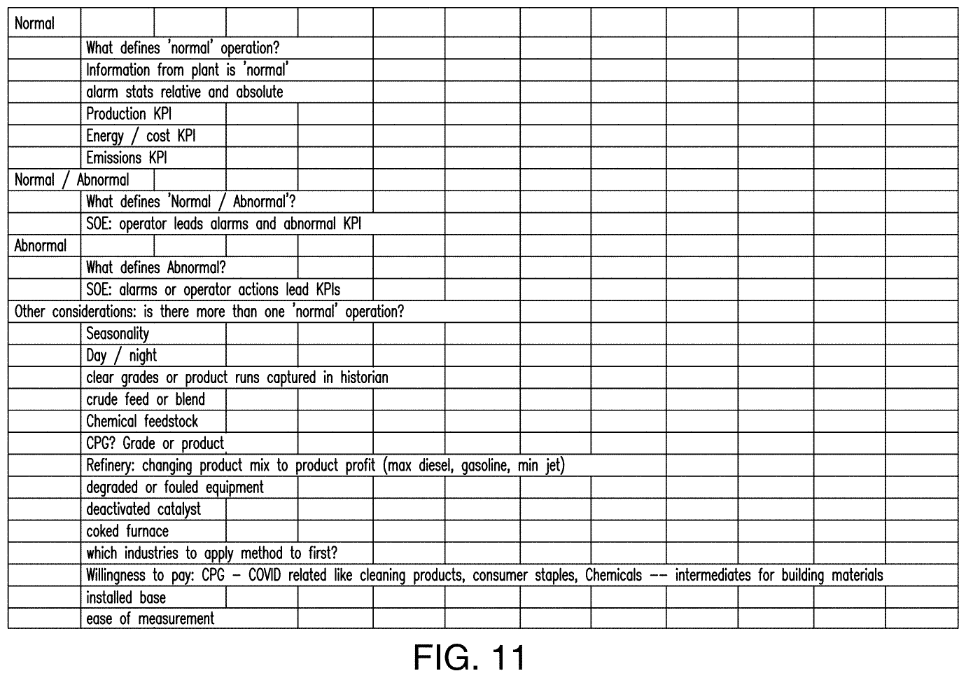

Because the transient operation relies so much on the operator, there is usually the highest amount of variation between operators. These differences can be substantially reduced with application of the best practice solutions shown in FIG. 11, for example. In this highly effective operating environment utilizing the best practice solutions, it is specifically designed to show the root cause of an abnormal situation or make it very intuitive to do so. For example, in a high performance HMI, the use of color is strictly associated with a process variable in an abnormal state. Since a single unit has hundreds or thousands of continuously measured variables, it is very difficult and time consuming for an operator to determine those in an abnormal state, those that first appeared in an abnormal state unless the HMI is designed for high performance in an abnormal situation.

Unfortunately, only 25% to 30% of control rooms utilize these high performance HMI's. The business case and the organizational switching cost has proven too high for many end users. That is one of the fundamental reasons for the body of work associated with the disclosed invention—to show clear business justification to adopt these current best practices.

Returning now to method 900, subsequent to blocks 915 and/or 920, one or more actions may be taken at block 925, for example, based on the mapping performed. For example, one or more actions may be taken based on or using the solution(s) identified as justified for addressing the gap(s) for the particular industrial operation in the mapping. In accordance with some embodiments of this disclosure, the one or more actions may include communicating information relating to the identified solution(s). The communicated information may include, for example, predicted economic benefits by implementing each of the identified solution(s). The information may be communicated, for example, via a report, text, email and/or audibly. The report, text, email (i.e., visual communications) and/or audible communications may occur, for example, on at least one user device (e.g., of an industrial operation plant manager). For example, the report, text, email (e.g., similar to that shown in FIG. 7) may be presented on at least one display device of the at least one user device, and the audible communications may be emitted through at least one speaker of the at least one user device.

Other example actions taken or performed based on or using the identified solution(s) may additionally or alternatively include storing information relating to the identified solution(s) (e.g., priority or ranking of the identified solution(s)), triggering, initiating or implementing (e.g., turning on or installing) the identified solution(s), and so forth. It is understood that the storing may occur on at least one local memory device (e.g., memory associated with at least one system and/or device in the industrial operation) and/or on at least one remote memory device (e.g., cloud-based memory). Additionally, it is understood that the triggering, initiating or implementing of the identified solution(s) may occur in a variety of manners. For example, the triggering, initiating or implementing may occur automatically, semi-automatically or manually. For example, the identified solution(s) may be triggered, initiated or implemented in response to receiving a control signal (e.g., generated by at least one system and/or device associated with the industrial operation). Additionally, the identified solution(s) may be triggered, initiated or implemented in response to at least one human interaction (e.g., installation or deployment of the identified solution(s), e.g., hardware or software).

In embodiments in which the identified solution(s) includes a plurality of solutions (e.g., as shown in FIG. 10), one or more of the plurality of solutions may be selected and implemented to address the one or more gaps. For example, the one or more of the plurality of solutions may be selected and implemented in accordance with one or more user specified rules. The user specified rules may include, for example, one or more of: predicted economic benefits and/or production gains by implementing the at least one identified solution, costs associated with implementing the at least one identified solution, and time required to implement the at least one identified solution. The user specified rules may be reflected in the ranking or prioritization of the solutions, as shown in FIG. 10, and as discussed above. In one example implementation, the highest priority or ranking solution(s) are selected and implemented to address the one or more gaps.

As illustrated in FIG. 6 under the “Map to Solutions” portion of the figure, and as shown in FIG. 10, many possible solutions for addressing gap(s) for a particular industrial operation are contemplated by this invention. For example, an adjustment or change to Operator Graphics may identified as a solution justified for addressing the gap(s) for a particular industrial operation. One example of an action that may be taken based on or using this identified solution is changing the DCS display from 1980's style ‘native window’ graphics with black background and several colors to situational awareness style high performance graphics that only show color when there is transient or abnormal operation. The operator action is considerably altered (to the best practice or best operator) by adopting the solution because the root cause and action are now very intuitive. It is understood that the solutions illustrated in FIGS. 6 and 10 and discussed in this disclosure are but a few of many possible solutions for addressing gap(s) for a particular industrial operation. In some instances, the list of possible solutions is a dynamic list that may changes over time, for example, in response to new or additional solutions being developed, in response to the needs of the particular industrial operation changing, etc. The list may be provided in a lookup table (LUT) format in some instances, for example, with common events (e.g., startups, shutdowns) being linked to actions or solutions and modified accordingly for the particular industrial operation. Additionally, the list may be provided in one or more other forms (e.g., a mapping chart, as shown in FIG. 10), as will be apparent to one of ordinary skill in the art.

It is also understood that the mapping of solutions to gap(s) for a particular industrial operation may change over time (i.e., be dynamic). For example, the mapping of solution(s) may change based on the needs and priorities (e.g., costs, production increases, etc.) of the particular industrial operation changing, new or additional solutions being developed (as noted above), and so forth. In accordance with some embodiments of this disclosure, the current needs and priorities of the particular industrial operation may be set or configured by an owner or manager of the industrial operation. Additionally, in accordance with some embodiments of this disclosure, the current needs and priorities of the particular industrial operation may be determined based on an analysis of the input data received from the one or more data sources and/or information received from an owner or manager of the industrial operation.

Further to the above, the mappings (i.e., the mapping of solutions to gap(s)) may be validated in some instances, for example, with updates being made to the mappings (e.g., and associated mapping table(s)) based on the validation. For example, the example mappings may be validated and optimized in response to user input and/or data received from one or more data sources. For example, an expert user may manually validate and optimize (e.g., update) the mappings in some instances. Additionally, at least one processing device (e.g., in the system for addressing gaps in the industrial operation) may validate and optimize the mappings in response to data/information received from a user and/or systems or devices in the industrial operation. In accordance with some embodiments of this disclosure, the at least one processing device may be trained, for example, with training data using machine learning techniques, and the mappings may be improved over time in response additional data (e.g., feedback data as a result of the validation(s) and mapping(s)) being received by the at least one processing device. It is understood that with respect to validation, a complete repeated Operator Effectiveness evaluation after the solution has been implemented is the best way to determine the impact on the gap or operator variability. As the automation and effectiveness of the control room/operating environment improves, there will be less variation between operators within each regime of operation.

Returning now to block 910, if it is alternatively determined that relevant characteristics associated with the gap(s) in the economic operation do not justify at least one solution for addressing the gap(s) for the particular industrial operation, the method may proceed to block 930, end, or return to block 905 (e.g., for analyzing new or additional measured/quantified/characterized gap(s) in the economic operation) in some instances. At block 930, it may be communicated or indicated that no solutions are justified for addressing the gap(s). For example, it may be communicated why no solutions are justified for addressing the gap(s). Similar to the embodiment discussed above in connection with block 925, the communication may take the form of a visual communication (e.g., report, text, email, etc.) and/or an audible communication (e.g., sound or sounds). Additionally, similar to the embodiment discussed above in connection with block 925, one or more other actions may be taken or performed. For example, the communication or indication may be stored (e.g., on at least one memory device). Additional example actions will be understood by one of ordinary skill in the art.

Subsequent to block 925 and/or block 930, the method may end in some embodiments. In other embodiments, the method may return to block 905 and repeat again (e.g., for analyzing new or additional gap(s) in the economic operation). In some embodiments in which the method ends after block 925 and/or block 930, the method may be initiated again in response to user input, automatically, periodically, and/or a control signal, for example.

Similar to the methods discussed above, it is understood that method 900 may include one or more additional blocks or steps in some embodiments, as will be apparent to one of ordinary skill in the art.

It is understood that there are many other features and extensions of this invention to be considered. For example, the following includes a brief list of features and extensions:
Systems and methods for collecting digital information in process control systems for correlation analysis of operator effectiveness may be provided.
   A data repository of control system measurements and actions may be used for benchmarking and then utilized as a tool to compare operator effectiveness in various industries within individual plants or between similar units at a plant. Measurements may include, but are not limited to, time in automatic control mode, time in Advanced Process Control mode, interventions by operators that can be defined as optimizing vs random adjustment, operator interventions per alarm, time to intervene in an alarm situation, operator time to configuration process loops and control elements, automatic versus manual transitions to a process, operator time to make tuning changes, number of alarm changes made by operators that deviate from designed level, HMI graphics metrics such as number of graphics viewed, time on a graphic, transitions between graphics, operator experience with a graphic, energy usage per production unit, production output, number of notifications/email from outside sources and number of communications with field personnel.
   Analytical or calculated data may also include, but not be limited to, shift to shift variation, shift hour variation, shift transition variation, fatigue: day vs night, Control room survey, Operator span of control, definition of normal operation, biases, quality or selectivity, fatigue, etc.
   Data will be collected in a secure manner from multiple companies to develop a cache of data on the metrics above. The data will be agnostic as to source but parsed per industrial application. Example data from specific units at a refinery, for example, will be separated from data from units at a power plant since metrics are applied differently from industry to industry.
   The data will be collected to a point where the data set is statistically significant and then it will be analyzed to determine any correlations between various metrics. Independent and dependent variables including, but not limited to, the following will be collected such as: production rate stability, the number of transitions between HMI graphics, the number of loops in manual versus automatic, energy usage in kilowatts per unit, the total time process loops are in manual vs automatic mode, the total transitions from manual to automatic control of a process, the tuning changes to control loops, the count of alarm changes, cross referencing above metrics with shift time of day, shift length, and shift manpower, cross referencing above metrics with experience levels of operators (is there more). The independent and dependent variables will be analyzed using regression analyses and other analytics to determine correlations between the independent and dependent variables. Any correlations found will support the definition of best practices at plants which will lead to key process indicators of operator effectiveness.
   The Abnormal Situation Management Consortium has found problems such as insufficient knowledge, procedure error, and operator error as being major factors contributing to the people component attributing to poor response to abnormal situations or differently said attributing to operator effectiveness in normal and abnormal situations. Additional research indicates that nearly 80% of production downtime is preventable and half of this is due to operator error. The costs of these failures in the petrochemical industry, for example, are estimated at $20 billion per year and approximately 80% of plant personnel indicated product quality was negatively affected.
   Operator actions can be linked to a variety of metrics and through a collection of metrics it will be shown that the metrics directly correlate to operator effectiveness. From this correlation monetary losses and quality will be improved.
Systems and methods for multivariate data analysis of digital process control information to determine operator effectiveness may be provided.
   Process data that is collected in a digital control system (DCS, SCADA, etc.) may be analyzed using a variety of statistical and higher-level data mining techniques that could include, but are not limited to, clustering, machine learning, multivariate analysis or specific algorithms. Data may be collected, for example, from a variety of systems that contain the activities of the operator relating to the information that is relayed to the operator. This data may include, but is not limited to, Alarms, Operator actions, HMI selections, process data, shift calendars, time of day, hour in shift, and more. The data and calculated metrics and analytics may be evaluated to understand operator performance or effectiveness and the effects those actions have upon outcomes and results within the process under control.
   The goal of the analysis is to define and calculate metrics that quantify the performance or effectiveness of the very actions and directions undertaken by human operators. Once properly analyzed and prioritized, these calculated metrics can be compared and contrasted in various ways to provide information which might better guide and inform those actions in the future. In addition, those actions and combinations of actions may be studied to discover newer and better ways to guide human interactions with control systems.
Systems and methods for prioritizing operator effectiveness impact, for example, using digital control system data and calculated metrics with tools to improve operator effectiveness, may be provided.
   In theory, a mathematical equation can be used to define Operations Effectiveness. For example, Operations Effectiveness may be defined as: Operations Effectiveness=People*Process*Technology. In accordance with some embodiments of this disclosure, each of the three components (People, Process, Technology) may have its own subcomponents. For our purposes, however, we will hold the Process and Technology components constant and focus on how to improve the sub-components of “People.” The idea is to maximize Operations Effectiveness with the “People” parameter in mind.
   In accordance with some embodiments of this disclosure, the appropriate People behaviors that maximize Operations Effectiveness can be achieved when these three components are present in console operators: 1) Appropriate skillset (Skills); 2) Appropriate tools available to optimally perform the job (Opportunity); and 3) Appropriate Motivation to do the job (Motivation).
   The analytics to be used will use a weighing algorithm to identify (out of the potential 100+ available solutions to improve operator effectiveness), which solutions provide the biggest return on investment.
   The solutions can help improve: 1) The operator skillset (via training, simulators, etc.), and/or 2) Improve the operator opportunity to do the job better (via Situation Awareness improvements, improved alarms, etc.), and/or 3) The solutions can point into areas to incentivize in order to motivate appropriate behaviors. In other words, the algorithm will prioritize solutions within a company's portfolio in order of biggest ROI for the customer.
   In accordance with some embodiments of this disclosure, the ultimate goal of the above-discussed approach is to influence customers' budget allocation and behaviors to align them with the most optimal way of deploying those resources. The conversations turn from focusing on “cost” to focusing on “value.”

Other example aspects and possible extensions of this invention will be appreciated by those of ordinary skill in the art.

As described above and as will be appreciated by those of ordinary skill in the art, embodiments of the disclosure herein may be configured as a system, method, or combination thereof. Accordingly, embodiments of the present disclosure may be comprised of various means including hardware, software, firmware or any combination thereof.

It is to be appreciated that the concepts, systems, circuits and techniques sought to be protected herein are not limited to use in the example applications described herein (e.g., industrial applications) but rather, may be useful in substantially any application where it is desired to monitor and manage operator performance. While particular embodiments and applications of the present disclosure have been illustrated and described, it is to be understood that embodiments of the disclosure not limited to the precise construction and compositions disclosed herein and that various modifications, changes, and variations can be apparent from the foregoing descriptions without departing from the spirit and scope of the disclosure as defined in the appended claims.

Having described preferred embodiments, which serve to illustrate various concepts, structures and techniques that are the subject of this patent, it will now become apparent to those of ordinary skill in the art that other embodiments incorporating these concepts, structures and techniques may be used. Additionally, elements of different embodiments described herein may be combined to form other embodiments not specifically set forth above.

Accordingly, it is submitted that that scope of the patent should not be limited to the described embodiments but rather should be limited only by the spirit and scope of the following claims.

What is claimed is:

1. A method for benchmarking operator performance for an industrial operation, the operators corresponding to humans that interact with at least one control system associated with the industrial operation, the method comprising:
receiving input data relating to the industrial operation from one or more data sources;
processing the input data to measure operator effectiveness and build a data repository for benchmarking/analytics, the data repository including information relating to the measured operator effectiveness;
identifying biggest contributors of operator variability based on an analysis of the data repository; and
taking one or more actions to reduce or eliminate the biggest contributors of operator variability.

2. The method of claim 1, wherein the input data is parsed per industrial application associated with the industrial operation, and the operator effectiveness is separately measured for each industrial application.

3. The method of claim 2, wherein each industrial application is associated with a different process or piece of equipment.

4. The method of claim 1, wherein the industrial operation is associated with a plurality of sites and/or a plurality of customers.

5. The method of claim 4, wherein the operator effectiveness is measured for each of the plurality of sites alone or in combination with other sites of the plurality of sites.

6. The method of claim 1, wherein the input data is collected to a point where a data set produced from the input data is determined to be statistically significant.

7. The method of claim 6, wherein the data set is analyzed to identify correlations between one or more metrics associated with the industrial operation, the one or more metrics including at least one of: production rate stability, number of transitions between HMI graphics, number of loops in manual versus automatic, energy usage in kilowatts per unit, total time process loops are in manual vs automatic mode, total transitions from manual to automatic control of a process, tuning changes to control loops, count of alarm changes.

8. The method of claim 7, wherein the one or more metrics are cross referenced with at least one of: shift time of day, shift length, shift manpower and experience levels of operators, to further identify the correlations.

9. The method of claim 7, wherein the one or more metrics are analyzed using regression analyses and/or other analytics to identify the correlations.

10. The method of claim 7, wherein the correlations are indicative of best practices at plants

11. The method of claim 7, wherein operator actions are linked to at least one of the one or more metrics, and the linking is used, at least in part, to measure the operator effectiveness.

12. The method of claim 1, wherein the data repository includes control system measurements and actions.

13. The method of claim 12, wherein the control system measurements and actions include one or more of: time in automatic control mode, time in Advanced Process Control (APC) mode, interventions by operators that can be defined as optimizing vs. random adjustment, operator interventions per alarm, time to intervene in an alarm situation, operator time to configuration process loops and control elements, automatic versus manual transitions to a process, operator time to make tuning changes, number of alarm changes made by operators that deviate from designed level, Human-Machine Interface (HMI) graphics metrics such as number of graphics viewed, time on a graphic, transitions between graphics, operator experience with a graphic, energy usage per production unit, production output, number of notifications/email from outside sources and number of communications with field personnel.

14. The method of claim 1, wherein the data repository includes analytical or calculated data, the analytical or calculated data including one or more of: shift to shift variation, shift hour variation, shift transition variation, fatigue: day vs night, Control room survey, Operator span of control, definition of normal operation, biases, quality or selectivity, and fatigue.

15. The method of claim 1, wherein the data repository is used as a tool to compare operator effectiveness in various industries within individual plants or between similar units at a plant.

16. The method of claim 1, wherein the input data includes at least one of: steady state process data, transient or non-steady state process data, and downtime data.

17. The method of claim 1, wherein the input data is received in digital form and includes one or more timestamps.

18. The method of claim 1, wherein the input data is received from one or more sensor devices or sensing systems associated with the industrial operation.

19. The method of claim 18, wherein at least one of the sensor devices or sensing systems is coupled to at least one piece of industrial equipment associated with the industrial operation and configured to measure output(s) of the at least one piece of industrial equipment.

20. The method of claim 18, wherein at least one of the sensor devices or sensing systems is configured to visually and/or audibly monitor the operators.

21. The method of claim 1, wherein the input data includes alarms, recorded operator actions and/or recorded operator navigation on a distributed control system (DCS), supervisory control and data acquisition (SCADA) system, or other control system in the industrial operation.

22. The method of claim 1, wherein the one or more data sources include plant databases of operator logs, overall equipment effectiveness and maintenance records.

23. The method of claim 1, wherein the biggest contributors of operator variability are further identified based on an analysis of information from one or more other systems or devices associated with the industrial operation.

24. The method of claim 1, further comprising:
determining impacts of the identified biggest contributors of operator variability on the industrial operation; and
prioritizing the identified biggest contributors of operator variability based on the determined impacts.

25. The method of claim 24, wherein tangible and intangible costs associated with the identified biggest contributors of operator variability are used to determine the impacts of the identified biggest contributors of operator variability.

26. The method of claim 24, wherein the one or more actions taken to reduce or eliminate the biggest contributors of operator variability are performed based, at least in part, on the prioritization.

27. The method of claim 1, wherein the one or more actions taken to reduce or eliminate the biggest contributors of operator variability, include: recommending specific automation, operator tools or modernization to reduce impact of the biggest contributors of operator variability on the industrial operation.

28. The method of claim 1, further comprising:
subsequent to taking the one or more actions to reduce or eliminate the biggest contributors of operator variability, identifying a next biggest contributor of operator variability; and
taking one or more actions to reduce or eliminate the next biggest contributor of operator variability.

29. A system for benchmarking operator performance for an industrial operation, the operators corresponding to humans that interact with at least one control system associated with the industrial operation, the system comprising:
at least one processor;
at least one memory device coupled to the at least one processor, the at least one processor and the at least one memory device configured to:
receive input data relating to the industrial operation from one or more data sources;
process the input data to measure operator effectiveness and build a data repository for benchmarking/analytics, the data repository including information relating to the measured operator effectiveness;
identify biggest contributors of operator variability based on an analysis of the data repository; and
take one or more actions to reduce or eliminate the biggest contributors of operator variability.

30. The system of claim 29, wherein the input data is parsed per industrial application associated with the industrial operation, and the operator effectiveness is separately measured for each industrial application.

31. The system of claim 30, wherein each industrial application is associated with a different process or piece of equipment.

32. The system of claim 29, wherein the industrial operation is associated with a plurality of sites, and the operator effectiveness is measured for each of the plurality of sites alone or in combination with other sites of the plurality of sites.
